(19) United States
(12) Patent Application Publication
(10) Pub. No.: US 2015/0104262 A1
(43) Pub. Date: Apr. 16, 2015

(54) ROUND TOOTH CUTTERS AND METHOD OF DESIGN AND USE

(71) Applicant: EIP Holdings, LLC, Houghton, MI (US)

(72) Inventors: William J. Endres, Houghton, MI (US); Douglas J. Woodruff, Atlantic Mine, MI (US); Ryan R. Kroll, Hancock, MI (US)

(21) Appl. No.: 14/502,035

(22) Filed: Sep. 30, 2014

Related U.S. Application Data
(63) Continuation-in-part of application No. 14/242,680, filed on Apr. 1, 2014.
(60) Provisional application No. 61/807,285, filed on Apr. 1, 2013.
(60) Provisional application No. 61/807,225, filed on Apr. 1, 2013.

(51) Int. Cl. B23C 5/20

(52) U.S. Cl. CPC B23C 5/20
USPC 407/56

(57) ABSTRACT

A device for mechanically removing material from a workpiece or bulk feedstock, thereby creating chips of removed material while producing a new surface on the workpiece or bulk feedstock. The device comprises a body that is rotatable about an axis and at least one round cutting insert that is tangentially mounted on the body. Location of the insert is characterized by a reference plane offset and an insert axis angle. The insert has a cylindrical rake surface on which chips are formed. A planar flank surface is oriented relative to a cutting motion so as to provide clearance between the cutting insert and the surface created by removal of a layer that is converted into chips. A circular cutting edge lies at the intersection of the flank and rake surfaces.

### CROSS REFERENCE TO RELATED APPLICATION

This application is a continuation in part of U.S. Ser. No. 14/242,680 filed Apr. 1, 2014 which claims the benefit of U.S. provisional application Ser. Nos. 61/807,285 and 61/807,225 both filed Apr. 1, 2013, the disclosures of which are hereby incorporated in their entirety by reference herein.

### BACKGROUND OF THE INVENTION

(1) Field of the Invention

This invention relates to devices for mechanically removing material from a workpiece or bulk feedstock, creating chips of removed material while producing a new surface on the workpiece or bulk feedstock.

(2) Description of Related Art

Machining processes are a subset within the broader realm of manufacturing processes where machining processes involve the separation of material from its parent piece. Generally, machining processes fall into classifications of “traditional”/“conventional”, whereby the material is removed through the application of mechanical energy to push one or more cutting teeth through the material to remove a layer of material from the parent piece, and “non-traditional”/“non-conventional”, whereby material is separated from the parent piece with either very limited or usually no mechanical energy, using instead thermal and/or chemical energy. Some examples of non-conventional machining processes include laser cutting/machining, electro-discharge machining (EDM), and electrochemical machining (ECM). Some examples of conventional machining processes, presented based on the types of surfaces they create, include:

Creation of two generally planar surfaces through use of a sawing process, where the saw blade is either translated in a plane that is parallel to the two surfaces being created or rotated about a spindle axis that is normal to the surfaces being created.

Creation of a surface that is externally or internally axisymmetric, through the use of, respectively, a turning or boring process, where the workpiece is rotated about a spindle axis that is coincident with the axis of said axisymmetric surface.

Creation of a surface that is internally cylindrical through the use of a cylinder boring or drilling process where, respectively, the boring bar or drill bit is rotated about a spindle axis that is coincident with the axis of said cylindrical surface.

Creation of a surface that is a substantially flat through the use of a face milling or end milling process where the milling tool is rotated about a spindle axis that is either normal to or parallel to said flat surface.

Creation of a surface that is three-dimensional or sculptured through the use of a milling process where a bull-nosed or ball-end milling tool is rotated about an axis that is either normal to or at a variable angle to said sculptured surface.

Processes such as grinding, lapping, and honing, whereby a relatively small amount of material is removed through mechanically working small grits of abrasive material over a surface, may also fall in the conventional machining processes classification in the sense that a relatively thinner layer of material is removed, though these processes focus on finishing a surface to a desired texture and are not generally used to change the gross shape/geometry of the surface. In other words, a machining process aims to create a new and generally different, more usable surface by removing material. The removed material is generally referred to as a “chip” and, along with worn out cutting tools, is a byproduct of the machining process.

Another set of processes that remove material from a parent piece is referred to as reduction processes. The similarity of reduction processes to conventional machining processes is that material is removed through the application of mechanical energy to push one or more cutting teeth through the material to remove a layer of material from the parent piece. Some terms often used to name specific reduction processes include chipping, chopping, shredding, grinding and milling, grinding and milling here being very different than grinding with abrasive grits and face milling or end milling noted earlier in that in the case of reduction “grinding and milling” generally involve brittle fracture of material through repeatedly smashing, crushing, and/or impacting with a blunt instrument/tool upon larger particles until a desired particle size is reached. The stark contrast is that in reduction processes the “chips” or particles that are formed are the desired product, not the byproduct (however, worn out tools are byproducts in common with machining processes). As such, the focus in reduction processes is on the chip/particle produced and not the surface that remains on the parent piece (bulk feedstock), and furthermore the objective in reduction processes is to fully consume the parent piece by converting it in its entirety into chips/particles, whereas in machining processes the objective is to retain a substantive amount of material in the parent piece, usually called the workpiece, which is ultimately intended to serve a function as part of a manufactured product.

Put another way, in order to focus on the precise purposes and desired products of conventional machining versus reduction processes, conventional machining processes make use of cutting teeth on or affixed to cutter bodies where the primary purpose is the removal of material from a workpiece, being either raw stock or material that has been previously worked into an intermediate surface finish, shape, and size, so that the new surface created on the workpiece is either a final surface having the final desired surface finish, shape, size, and/or position relative to other geometric feature(s) on the workpiece, or is an intermediate surface produced enroute to achieving through subsequent use of this or other manufacturing processes the final surface of desired surface finish, shape, size, and/or position relative to other geometric feature(s) on the workpiece. In conventional machining processes, either the cutter body or the workpiece may provide the cutting motion, usually by way of relatively high speed rotation of the cutter body or the workpiece. In contrast, reduction processes make use of teeth affixed to either a drum or disc that is rotated at relatively high speed to provide a cutting motion where the primary purpose is to reduce feedstock material pieces, in their entirety or to the extent possible given requirements for holding and supporting the feedstock material pieces, from their relatively large size into particles of relatively smaller size either with or without regard to the shape and/or size of the particles.

Some examples of reduction processes, presented based on the types of feedstock they reduce, include:
Reduction of woody biomass, including but not limited to whole trees, tree stumps, tree trunks, tree limbs, tree branches, and brush.
Reduction of grassy biomass, including but not limited to grasses, leafy material, and agricultural residues like corn stover and wheat straw.
Reduction of construction materials and industrial or commercial byproducts, including but not limited to wood, plywood, gypsum, cement board, oriented strand board (OSB), and shingles.
Reduction of various materials, including but not limited to plastics and metals, as a step in their recycle.
Reduction of concrete, asphalt or other aggregate-based roadway and/or structural material, including but not limited to an in-place roadway or structure and remnants of roadways or structures.
Reduction of whole products or product subsystems, including but not limited to household appliances and automobiles, as a step in their recycle.
Reduction of logs for use in the manufacture of particle board and, in addition, into strands rather than particles for use in the manufacture of oriented strand board (OSB).

Depending on the industry and/or the type of feedstock and/or the type of removal mechanism (sharp-edged cutting versus tearing apart versus blunt fracture), the processes go by various names such as but not limited to chipping, chopping, grinding, shredding, granulating, and milling. In fact, the use of some of these names at some times is not necessarily a very precise picture of the removal mechanism. For example, machines used to reduce plastics in the process of recycling are often called grinders or granulators, the latter generally producing more consistently and smaller-sized particles, whereas in fact they both work using sharp-edged teeth that cut through the material at high speed without use of crushing as is the case for “grinders” in other industries, and these are in contrast to shredders that operate at low speed and tear apart the plastic into more random sized and shaped particles/pieces of relatively large size (e.g., one or more inch versus fractions of an inch). Examples like chipping of woody biomass and chopping of grassy biomass are well reflective of the reduction mechanism (sharp-edged cutting).

Reduction machines of interest for the present invention generally operate at high speeds and involve the mechanism of sharp-edged cutting rather than tearing apart or blunt fracture. They have an opening to the reduction chamber through or into which feedstock is fed/pushed. The feedstock then encounters a rotating drum or disc to which multiple teeth are affixed. The feedstock is supported on the side opposite the direction of approach of the tooth by an anvil surface. Each tooth, as it rotates past the feedstock, encounters the feedstock making contact with the feedstock to form one or more chips/particles. The machines on which reduction processes take place go by various names. Brush chippers and whole-tree chippers are generally used to chip woody biomass by feeding the wood material horizontally into the machine; the machine uses very wide teeth, typically referred to as knives, affixed to a drum or disc. Other machines, referred to as horizontal grinders or recyclers, are fed horizontally and employ a drum affixed to which are teeth that are generally axially shorter than the aforementioned knives. Another type of machine is a tub grinder which is fed vertically by depositing the feedstock into a large tub in which teeth are affixed to a rotating disc/ring, and generally employ a tearing mechanism; unlike the others of interest these tend to operate at low speeds. The term rotary shredder is used for machines in the paper, plastics and whole-products recycling industry. Then again, what was referred to as horizontal “grinders” are referred to by some companies as “shredders” and “shredders” used for recycling paper, etc. are referred to by others as “grinders” at times.

The subset of reduction processes to which the present invention applies are those where chips/particles are created through a high-speed cutting action using a sharp-edged tooth, as opposed to tearing apart at relatively low speed or inducing fracture through smashing, crushing, and/or impacting with a more blunt implement/tool. However, some of the reduction machines that were originally designed to employ tearing and/or fracture instead of cutting may be outfitted with alternative teeth to result in sharp-edged cutting rather than tearing and fracturing. This is advantageous for many materials, those that are not extremely brittle, in that sharp-edged cutting is more efficient than tearing and blunt-implement fracture by 30% to 60%.

Having differentiated between conventional machining processes and reduction processes that employ a sharp-edged cutting action, prior art in the realm of conventional machining processes is introduced as the foundation of the present innovation. The focus is on the use of round cutting teeth as the present invention explicitly makes use of round cutting teeth, but in a way that is fundamentally different than prior art in both the individual tooth geometry and the way in which the round teeth are oriented relative to the cutting and feeding motions of the process.

In conventional machining processes, a “cutting tooth” is generally defined to have a rake face, a flank face, and a cutting edge defined by the intersection of the rake face and flank face. The rake face is the surface on which the chip is formed and contacts the cutting tooth. The flank face is oriented relative to the cutting motion so as to provide clearance between the cutting tooth and the surface just created by removal of the layer that is converted into chips. In modern conventional machining processes, a cutting tooth is often made up of an indexable “cutting insert” that is affixed to the cutter body so that a worn out cutting edge may be readily and easily replaced with a fresh cutting edge. The term indexable refers to the ability to index the cutting edge to a fresh one, very often to another useable cutting edge on the same cutting insert.

Cutting inserts are generally prismatic having a cross-section of a particular shape, such as but not limited to triangular, square, rhombic, pentagonal, hexagonal, octagonal and circular/round, which is then extruded (not literally, but from the perspective of creating a CAD model where a cross-sectional sketch is drawn and then “extruded” to create the three-dimensional solid) to some thickness of the cutting insert. Using a square cutting insert as an example, the rake face would be the square-shaped surface where each of the four corners would provide a useable cutting edge, allowing the cutting insert to be indexed from one corner to the next until all four corners have been consumed. Some cutting inserts have a clearance face that is not normal to the rake face, that is, the included angle between the rake face and the clearance face at any point on the cutting edge is less than 90°. This provides clearance, relative to the machined surface, that is built into the cutting insert. In this case, the exemplary square cutting insert would have the four useable corners/edges noted. Other cutting inserts have a 90° included angle between the rake face and the clearance face, in which case the cutting insert can generally be flipped over to achieve another four corners (for the exemplary square cutting insert) for a total of eight useable corners. It is noted that a round cutting insert, having a round rake face, has a cylindrical or slightly conical flank surface, thus the use of the term “face” for the flank face may be construed in this instance to be more generally a surface rather than a planar “face”. Furthermore, the corners on polygonal shaped cutting inserts often have a small radius, called the corner radius, that blends the adjacent sides of the polygonal shaped rake face, and in such cases the flank of the tool in the region of the corner radius is not a planar surface as it too is radiused to extend consistently from the corner radiused cutting edge.

It is recognized that many cutting inserts at the current state of the art do not have a planar rake face; rather, they have a rake surface that at a macro scale has a planar reference upon or relative to which bumps, divots, ridges, groves, dishes, and other smaller-scale features are placed and/or superimposed. This can be the case for rake-flank included angles of 90° or less than 90°. These smaller geometric features are generally patterned symmetrically about each corner so that each corner/edge has the same sized, shaped and positioned geometric features as all the other corners/edges. They are often referred to as “chip control” geometry, but their purpose can extend beyond that of controlling chip flow to also permitting more preferential shear conditions for chip formation.

Another class of cutting inserts is generally referred to as “tangential mount”. They too are prismatic having a thickness and a cross-sectional shape. However, it is the surface in the thickness dimension that serves as the rake face and the surface making up the cross-sectional shape that serves as the flank face. These inserts are affixed to the cutter body so that the thickness dimension is presented to the material so that it forms the chip, often being used on rotating cutters (e.g., face mills and cylinder boring tools) and customarily referred to as tangentially-mounted inserts. To achieve favorable shear, chip flow and clearance geometry, tangentially-mounted inserts are generally restricted to triangular, square or rhombic cross-section; that is, not hexagonal, octagonal, round, etc.

In the case of round cutting inserts, the number of useable edges or corners is not defined by their cross-section, as a circle has no corners. That is, a square insert has four corners per side, a triangular insert has three corners per side, a hexagonal insert has six corners per side, and so on. A round insert may be made with faceted or other geometric features on its thickness dimension or on its back side (making it an insert with a single useable side) in a way that promotes easy indexing a pre-set number of times giving a set number of useable edges, or arc segments. Otherwise, it is the responsibility of the tool setter to determine how much the insert should be rotated about its axis to present a new fresh arc segment of cutting edge. However, another unique capability of cutting with round inserts is that the insert may be allowed to rotate while it cuts (U.S. Pat. No. 6,073,524, U.S. Pat. No. 6,135,680, U.S. Ser. No. 12/350,181). With the introduction of the self-propelled rotary tool (SPRT) years ago, a round tooth/insert could now passively rotate as a result of mounting it on a bearing that does not support the rotational degree of freedom. The rotating motion is induced by setting the side rake angle such that the chip flow on the tool rake face induces enough lateral force, call it tangential to the round tooth, so as to rotate the tooth on its bearing; the side rake angle and back rake angle are projections of the rake face into two orthogonal planes as one means of defining the orientation of the rake face relative to the cutting and feeding motions. While the side rake angle is generally set higher than on many other tools, in the range of 10° to 25° (or −10° to β25°), typically, the back rake angle is generally no different than usual cutting teeth, set typically in the range of −5° to +5°. These rotary teeth are then mounted in place of standard fixed teeth on a face mill, at the end of a cylinder boring bar, or on a lathe-turning or facing tool.

Because the round insert in a SPRT is rotating, either continuously or intermittently, while it is cutting material, it is indexing itself to all useable portions of the round cutting edge without human intervention. In addition to reducing the burden of tool change downtime and indexing, every portion of the round cutting edge is used, and equivalently so. Also, when cutting metals, where significantly high temperatures are generated, rotating the tooth spreads the heat source on a continual basis around the entire circumference of the tooth. This allows tools to run faster without unduly compromising tool life, that is, without unduly increasing wear rate, which increases with cutting temperature, which increases with cutting speed. A final advantage of SPRTs is that some of the sliding friction between the chip and the tool is converted into the lower friction (rolling or plain) bearing, hence reducing the frictional component of the cutting power needed, ultimately reducing the specific cutting energy (energy per unit volume removed).

Turning to reduction processes and the cutting elements used in them, “teeth” are often single-edged (e.g., a long/wide wood-chipper/grass/hay-chopper knife) or possibly a two-edged v-shaped protrusion to the drum as is seen in some plastics grinders. Some knives may be flipped around 180° to a second useable edge. Round teeth are not generally used for reduction applications, with the exception of U.S. Pat. No. 5,961,057A and U.S. Pat. No. 6,257,511B1 that make use of a round insert in a way that is similar to one specific embodiment of the present invention.

In reduction processes, it is generally advantageous to use back rake angles of much more positive value, like+30° or greater; this is favorable since it better cuts through the material. This is realizable since many of the materials being reduced (including but not limited to woody and grassy biomass, scrap wood, felt-and-asphalt shingles, gypsum, plastics, cardboard, paper) are of much lower strength, and thus do not need the higher cutting edge strength that comes with back rake angles around −5° to +5° as is required to avoid cutting-edge fracture when cutting higher strength materials (e.g., metals) that are often machined with conventional machining processes. Furthermore, extremely high heat is often not characteristic of reduction processes, given that the materials usually of interest are woody or grassy biomass, construction waste, plastics, cardboard and paper. However, the conversion of friction to (rolling or plain) bearings to achieve more energy efficient cutting is relevant in reduction processes and, at least in the case of woody biomass by the nature of the mechanics associated with forming a wood chip (both slicing through the fibers and the extreme friction due to the wedge indentation that takes place in a way not seen in metal cutting), it is very advantageous showing in lab testing more than 25% reduction in specific energy compared to a stationary knife of equivalent back-rake angle. And, as in conventional machining processes, anything that reduces the need to shut down the equipment for tooth changes is advantageous, even more so in many cases since, unlike in conventional machining processes where a cutting tool may be rather rapidly removed from the machine to index inserts while an alternate tool is installed on the machine allowing it to continue being productive, the drums and discs on reduction machines are very large and not readily removed, resulting in machine down-time equivalent to the time it takes to change all the teeth/knives. The desire to reduce down time for tool changes was also noted in U.S. Pat. No. 5,961,057A and U.S. Pat. No. 6,257,511B1 where the round cutting teeth that are bolted to the chipper disc may be loosened, rotated (i.e., indexed), then retightened. The round tooth and its usage bear similarity to the present invention in a chipper disc embodiment. While the round teeth in U.S. Pat. No. 5,961,057A and U.S. Pat. No. 6,257,511B1 exhibit a positive “reference plane offset” (as defined later as the first of two cutter design variables of the present invention), there is no explicit notation of similar design parameters and as such they differ from the present invention in the following ways:
1. the “insert axis angle” (defined later as the second of two cutter design variables of the present invention) of the teeth appears to be greater than zero in U.S. Pat. No. 5,961,057A and U.S. Pat. No. 6,257,511B1, specifically noted to be either 2.5° or 3°, whereas in the chipper disc embodiment of the present invention this angle is explicitly greater than zero when the reference plane offset is greater than zero and less than zero when the reference plane offset is less than zero, generally but without limitation falling in the range of +5° to +30° when the reference plane offset is greater than zero or −5° to −30° when the reference plane offset is less than zero,
2. adjacent teeth of the present invention substantially overlap one another from the perspective of the cutting (disc tangential) direction whereas they are generally adjacent to one another in U.S. Pat. No. 5,961,057A and U.S. Pat. No. 6,257,511B1, and
3. the round teeth of U.S. Pat. No. 5,961,057A and U.S. Pat. No. 6,257,511B1 are rigidly affixed to the chipper disc whereas the present invention may have its round teeth either fixed or allowed to rotate about the axis of the round tooth.

### BRIEF SUMMARY OF THE INVENTION

This invention relates to devices for mechanically removing material from a workpiece or bulk feedstock, creating chips of removed material while producing a new surface on the workpiece or bulk feedstock.

Turning back to the desire to reduce tool-change downtime, embodiments of the present invention allow the round teeth to rotate passively during cutting. There is then no need to loosen a bolt or other fixed clamping/attachment mechanism to manually rotate the round or other shaped cutting insert or knife. The present invention, in its rotating form, does not eliminate tool-change downtime. Because an “equivalent rotary-tooth knife” has approximately (depending on the specific spacing/overlap of adjacent teeth) 4-6 times more cutting edge (the entire circumference of all the adjacent teeth) that is continually active in the process, much more time (4-6 times that of the equivalent standard knife, for example) can elapse between machine shut-downs. In some conventional machining process embodiments, the geometric equivalent number of cutting edges can be as high as 20. And, in prior art SPRT applications, with the additional reduction in wear rate due to spreading heat as noted earlier, for equivalent conditions with a fixed cutting insert, the time between tool changes can be increased by a factor of 30 or more.

### BRIEF DESCRIPTION OF THE SEVERAL VIEWS OF THE DRAWINGS

FIG. 1 is a round cutting insert with the flank surface and rake surface called out as they would be in a conventional mounting of a round cutting insert.

FIG. 2 is a round cutting insert with the flank surface and rake surface called out as they would be in a tangential mounting of a round cutting insert per the present invention.

FIG. 3a illustrates a three-dimensional view of a single round cutting insert tangentially mounted to a rotating cutter body in the “tangential-mount neutral” state.

FIG. 3b illustrates a side view of a single round cutting insert tangentially mounted to a rotating cutter body in the “tangential-mount neutral” state.

FIG. 3c illustrates a front/end view of a single round cutting insert tangentially mounted to a rotating cutter body in the “tangential-mount neutral” state.

FIG. 3d illustrates a top view of a single round cutting insert tangentially mounted to a rotating cutter body in the “tangential-mount neutral” state.

FIG. 4a illustrates a three-dimensional view of a single round cutting insert tangentially mounted to a rotating cutter body in one of two “conventional-mount neutral” states.

FIG. 4b illustrates a side view of a single round cutting insert tangentially mounted to a rotating cutter body in one of two “conventional-mount neutral” states.

FIG. 4c illustrates a front/end view of a single round cutting insert tangentially mounted to a rotating cutter body in one of two “-conventional-mount neutral” states.

FIG. 4d illustrates a top view of a single round cutting insert tangentially mounted to a rotating cutter body in one of two “-conventional-mount neutral” states.

FIG. 5a illustrates a top view of a single round cutting insert tangentially mounted to a rotating cutter body in one of two “-conventional-mount neutral” states.

FIG. 5b illustrates a front/end view of a single round cutting insert tangentially mounted to a rotating cutter body in one of two “-conventional-mount neutral” states.

FIG. 5c illustrates a side view of a single round cutting insert tangentially mounted to a rotating cutter body in one of two “-conventional-mount neutral” states.

FIG. 5d illustrates a three-dimensional view of a single round cutting insert tangentially mounted to a rotating cutter body in one of two “conventional-mount neutral” states.

FIG. 6a illustrates a three-dimensional view of a single round cutting insert tangentially mounted to a rotating cutter body with the two cutter design variables—reference plane offset and insert axis angle—both greater than zero.

FIG. 6b illustrates a side view of a single round cutting insert tangentially mounted to a rotating cutter body with the two cutter design variables—reference plane offset and insert axis angle—both greater than zero.

FIG. 6c illustrates a front/end view of a single round cutting insert tangentially mounted to a rotating cutter body with the two cutter design variables—reference plane offset and insert axis angle—both greater than zero.

FIG. 6d illustrates a top view of a single round cutting insert tangentially mounted to a rotating cutter body with the two cutter design variables—reference plane offset and insert axis angle—both greater than zero.

FIG. 7a illustrates a side view of a single round cutting insert tangentially mounted to a rotating cutter body with the reference plane offset set to less than zero (insert axis angle is set to zero).

FIG. 7b illustrates a front/end view of a single round cutting insert tangentially mounted to a rotating cutter body with the reference plane offset set to less than zero (insert axis angle is set to zero).

FIG. 7c illustrates a top view of a single round cutting insert tangentially mounted to a rotating cutter body with the reference plane offset set to less than zero (insert axis angle is set to zero).

FIG. 8a illustrates a top view of a single round cutting insert conventionally mounted to a rotating cutter body with the reference plane offset set to less than zero (insert axis angle is set to zero).

FIG. 8b illustrates a front/end view of a single round cutting insert conventionally mounted to a rotating cutter body with the reference plane offset set to less than zero (insert axis angle is set to zero).

FIG. 8c illustrates a side view of a single round cutting insert conventionally mounted to a rotating cutter body with the reference plane offset set to less than zero (insert axis angle is set to zero).

FIG. 8d illustrates a three-dimensional view of a single round cutting insert conventionally mounted to a rotating cutter body with the reference plane offset set to less than zero (insert axis angle is set to zero).

FIG. 9a illustrates a side view of a single round cutting insert conventionally mounted to a rotating cutter body with the reference plane offset set to greater than zero (insert axis angle is set to zero).

FIG. 9b illustrates a front/end view of a single round cutting insert conventionally mounted to a rotating cutter body with the reference plane offset set to greater than zero (insert axis angle is set to zero).

FIG. 9c illustrates a top view of a single round cutting insert conventionally mounted to a rotating cutter body with the reference plane offset set to greater than zero (insert axis angle is set to zero).

FIG. 10a illustrates a side view of a peripheral end mill, slab mill, or chipper drum having multiple round cutting inserts tangentially mounted to a rotating cutter body with the reference plane offset set to greater than zero and the insert axis angle set to greater than zero (but less than 90°).

FIG. 10b illustrates a front/end view of a peripheral end mill, slab mill, or chipper drum having multiple round cutting inserts tangentially mounted to a rotating cutter body with the reference plane offset set to greater than zero and the insert axis angle set to greater than zero (but less than 90°).

FIG. 10c illustrates a three-dimensional view of a peripheral end mill, slab mill, or chipper drum having multiple round cutting inserts tangentially mounted to a rotating cutter body with the reference plane offset set to greater than zero and the insert axis angle set to greater than zero (but less than 90°).

FIG. 11a illustrates a side view of a peripheral end mill, slab mill, or chipper drum having multiple round cutting inserts tangentially mounted to a rotating cutter body with the reference plane offset set to greater than zero and the insert axis angle set to greater than zero (and greater than 90°).

FIG. 11b illustrates a front/end view of a peripheral end mill, slab mill, or chipper drum having multiple round cutting inserts tangentially mounted to a rotating cutter body with the reference plane offset set to greater than zero and the insert axis angle set to greater than zero (and greater than 90°).

FIG. 12a illustrates a side view of a peripheral end mill, slab mill, or chipper drum having multiple round cutting inserts tangentially mounted to a rotating cutter body with the reference plane offset set to greater than zero and the insert axis angle set to greater than zero (less than 90° for one axial region of the cutter and greater than 90° for the other axial region of the cutter).

FIG. 12b illustrates a front/end view of a peripheral end mill, slab mill, or chipper drum having multiple round cutting inserts tangentially mounted to a rotating cutter body with the reference plane offset set to greater than zero and the insert axis angle set to greater than zero (less than 90° for one axial region of the cutter and greater than 90° for the other axial region of the cutter).

FIG. 12c illustrates a three-dimensional view of a peripheral end mill, slab mill, or chipper drum having multiple round cutting inserts tangentially mounted to a rotating cutter body with the reference plane offset set to greater than zero and the insert axis angle set to greater than zero (less than 90° for one axial region of the cutter and greater than 90° for the other axial region of the cutter).

FIG. 13a illustrates a side view (and entering the workpiece) of a right-handed cylinder boring tool having multiple round cutting inserts tangentially mounted to a rotating cutter body with the reference plane offset set to greater than zero and the insert axis angle set to greater than zero.

FIG. 13b illustrates a front/end view of a right-handed cylinder boring tool having multiple round cutting inserts tangentially mounted to a rotating cutter body with the reference plane offset set to greater than zero and the insert axis angle set to greater than zero.

FIG. 14a illustrates a front/end view of a left-handed cylinder boring tool having multiple round cutting inserts tangentially mounted to a rotating cutter body with the reference plane offset set to greater than zero and the insert axis angle set to greater than zero.

FIG. 14b illustrates a side view (and entering the workpiece) of a left-handed cylinder boring tool having multiple round cutting inserts tangentially mounted to a rotating cutter body with the reference plane offset set to greater than zero and the insert axis angle set to greater than zero.

FIG. 15a illustrates a three-dimensional view (and feeding across the workpiece) of a right-handed face milling tool having multiple round cutting inserts tangentially mounted to a rotating cutter body with the reference plane offset set to greater than zero and the insert axis angle set to greater than zero.

FIG. 15b illustrates a side view of a right-handed face milling tool having multiple round cutting inserts tangentially mounted to a rotating cutter body with the reference plane offset set to greater than zero and the insert axis angle set to greater than zero.

FIG. 15c illustrates a front/end view of a right-handed face milling tool having multiple round cutting inserts tangentially mounted to a rotating cutter body with the reference plane offset set to greater than zero and the insert axis angle set to greater than zero.

FIG. 15d illustrates a top view of a right-handed face milling tool having multiple round cutting inserts tangentially mounted to a rotating cutter body with the reference plane offset set to greater than zero and the insert axis angle set to greater than zero.

FIG. 16a illustrates a top view of a left-handed face milling tool having multiple round cutting inserts tangentially mounted to a rotating cutter body with the reference plane offset set to greater than zero and the insert axis angle set to greater than zero.

FIG. 16b illustrates a front/end view of a left-handed face milling tool having multiple round cutting inserts tangentially mounted to a rotating cutter body with the reference plane offset set to greater than zero and the insert axis angle set to greater than zero.

FIG. 16c illustrates a side view of a left-handed face milling tool having multiple round cutting inserts tangentially mounted to a rotating cutter body with the reference plane offset set to greater than zero and the insert axis angle set to greater than zero.

FIGS. 16d, 16e and 16f illustrate respectively a three-dimensional side and end view of a right-handed face milling tool having multiple tooth sets each having multiple round cutting inserts tangentially mounted to a rotating cutter body with the reference plane offset set to greater than zero and the insert axis angle set to greater than zero.

FIG. 17a illustrates a top view of a right-handed face milling tool having multiple round cutting inserts conventionally mounted to a rotating cutter body and one round wiper tooth insert tangentially mounted with the reference plane offset set to less than zero and the insert axis angle set to slightly less than zero.

FIG. 17b illustrates a front/end view of a right-handed face milling tool having multiple round cutting inserts conventionally mounted to a rotating cutter body and one round wiper tooth insert tangentially mounted with the reference plane offset set to less than zero and the insert axis angle set to slightly less than zero.

FIG. 17c illustrates a side view of a right-handed face milling tool having multiple round cutting inserts conventionally mounted to a rotating cutter body and one round wiper tooth insert tangentially mounted with the reference plane offset set to less than zero and the insert axis angle set to slightly less than zero.

FIG. 18a illustrates a top view of a right-handed face milling tool having multiple round cutting inserts conventionally mounted to a rotating cutter body and one round wiper tooth insert tangentially mounted with the reference plane offset set to greater than zero and the insert axis angle set to slightly greater than zero.

FIG. 18b illustrates a side view of a right-handed face milling tool having multiple round cutting inserts conventionally mounted to a rotating cutter body and one round wiper tooth insert tangentially mounted with the reference plane offset set to greater than zero and the insert axis angle set to slightly greater than zero.

FIG. 18c illustrates a front/end view of a right-handed face milling tool having multiple round cutting inserts conventionally mounted to a rotating cutter body and one round wiper tooth insert tangentially mounted with the reference plane offset set to greater than zero and the insert axis angle set to slightly greater than zero.

FIG. 19a illustrates a top view of a right-handed chipper disc having a single representative round cutting insert tangentially mounted to a rotating cutter body with the reference plane offset set to greater than zero and the insert axis angle set to greater than zero.

FIG. 19b illustrates a side view of a right-handed chipper disc having a single representative round cutting insert tangentially mounted to a rotating cutter body with the reference plane offset set to greater than zero and the insert axis angle set to greater than zero.

FIG. 19c illustrates a front/end view of a right-handed chipper disc having a single representative round cutting insert tangentially mounted to a rotating cutter body with the reference plane offset set to greater than zero and the insert axis angle set to greater than zero.

FIG. 20a illustrates a top view of a right-handed chipper disc having two tooth sets of multiple round cutting inserts each that are tangentially mounted to a rotating cutter body with the reference plane offset set to greater than zero and the insert axis angle set to greater than zero.

FIG. 20b illustrates a side view of a right-handed chipper disc having two tooth sets of multiple round cutting inserts each that are tangentially mounted to a rotating cutter body with the reference plane offset set to greater than zero and the insert axis angle set to greater than zero.

FIG. 20c illustrates a front/end view of a right-handed chipper disc having two tooth sets of multiple round cutting inserts each that are tangentially mounted to a rotating cutter body with the reference plane offset set to greater than zero and the insert axis angle set to greater than zero.

FIG. 21a illustrates a top view of a right-handed chipper disc having two tooth sets of multiple round cutting inserts each that are tangentially mounted to a rotating cutter body with the reference plane offset set to less than zero and the insert axis angle set to less than zero.

FIG. 21b illustrates a front/end view of a right-handed chipper disc having two tooth sets of multiple round cutting inserts each that are tangentially mounted to a rotating cutter body with the reference plane offset set to less than zero and the insert axis angle set to less than zero.

FIG. 21 c illustrates a side view of a right-handed chipper disc having two tooth sets of multiple round cutting inserts each that are tangentially mounted to a rotating cutter body with the reference plane offset set to less than zero and the insert axis angle set to less than zero.

FIG. 22a illustrates a top view of a right-handed abstract extension to a lathe turning tool having a single round cutting insert that is tangentially mounted to a rotating cutter body with the reference plane offset set to less than zero and the insert axis angle set to less than zero.

FIG. 22b illustrates a front/end view of a right-handed abstract extension to a lathe turning tool having a single round cutting insert that is tangentially mounted to a rotating cutter body with the reference plane offset set to less than zero and the insert axis angle set to less than zero.

FIG. 22c illustrates a side view of a right-handed abstract extension to a lathe turning tool having a single round cutting insert that is tangentially mounted to a rotating cutter body with the reference plane offset set to less than zero and the insert axis angle set to less than zero.

FIG. 23 illustrates a three-dimensional view of an actual right-handed lathe turning tool cutting a workpiece and having a single round cutting insert that is tangentially mounted to a non-rotating cutter body; the reference plane offset is set to less than zero and the insert axis angle is set to less than zero.

FIG. 24 illustrates a three-dimensional view of an actual right-handed lathe facing tool cutting a workpiece and having a single round cutting insert that is tangentially mounted to a non-rotating cutter body; the reference plane offset is set to less than zero and the insert axis angle is set to less than zero.

FIG. 25 is an actual right-handed indexable insert drill having a central cutting element and multiple conventionally-mounted cutting inserts on each of the two cutting lips.

FIG. 26 illustrates a right-handed indexable insert drill having a central cutting element and multiple tangentially-mounted cutting inserts on each of the two cutting lips.

FIG. 27a illustrates a side view of a right-handed circular saw having multiple sets of multiple round cutting inserts that are tangentially mounted to a rotating cutter body with the reference plane offset set to greater than zero and the insert axis angles set to greater than zero.

FIG. 27b illustrates a front/end view of a right-handed circular saw having multiple sets of multiple round cutting inserts that are tangentially mounted to a rotating cutter body with the reference plane offset set to greater than zero and the insert axis angles set to greater than zero.

FIG. 28 illustrates a round cutting insert of the present invention having a central hole for mounting it to a cutter body.

FIG. 29a illustrates a round cutting insert of the present invention with material removed from the cylindrical rake surface creating a conical rake surface.

FIG. 29b illustrates a round cutting insert of the present invention with material removed from the cylindrical rake surface in the form of a groove on the cylindrical surface adjacent the cutting edge.

FIG. 30 illustrates a round cutting insert of the present invention with material added to one of the two planar surfaces creating a conical flank surface.

FIG. 31a illustrates a round cutting insert of the present invention with material added to one of the two planar surfaces in a way that creates a curved (non-conical) flank surface.

FIG. 31b illustrates a round cutting insert of the present invention with material removed from one of the two planar surfaces creating an inwardly conical flank surface.

FIG. 32a illustrates a round cutting insert of the present invention with material removed from the cylindrical rake surface creating a conical rake surface and with this applied to both axial ends of the insert resulting in two cutting edges.

FIG. 32b illustrates a round cutting insert of the present invention with material removed from the cylindrical rake surface creating a conical rake surface and with this applied to both axial ends of the insert resulting in two cutting edges, the two conical rake surfaces being blended at their intersection, and material added to both planar surfaces to create conical flank surfaces.

FIG. 33a illustrates a round cutting insert of the present invention with material removed from the cylindrical rake surface as a groove adjacent the cutting edge and with this applied to both axial ends of the insert resulting in two cutting edges with a groove adjacent to each.

FIG. 33b illustrates a round cutting insert of the present invention with material removed from the cylindrical rake surface as a groove adjacent the cutting edge and with this applied to both axial ends of the insert resulting in two cutting edges with a groove adjacent to each and material added to both planar surfaces to create conical flank surfaces.

FIG. 34a illustrates a round cutting insert of the present invention with a counter-bore recess on both planar surfaces to receive a mounting element.

FIG. 34b illustrates a round cutting insert of the present invention with a countersink recess on both planar surfaces to receive a mounting element.

FIG. 35a illustrates a round cutting insert of the present invention with one or more small grooves in each of the two flank surfaces and extending from a countersink recess and stopping radially just short of the two cutting edges.

FIG. 35b further illustrates a round cutting insert of the present invention with one or more small grooves in each of the two flank surfaces and extending from a countersink recess and stopping radially just short of the two cutting edges.

FIG. 36 illustrates a round cutting insert of the present invention with one or more small grooves in each of the two flank surfaces and extending from a countersink recess to and through each of the two cutting edges.

FIG. 37a illustrates a mounting element and how it attaches the round cutting insert of the present invention to a cutter body while allowing rotation about the insert axis.

FIG. 37b illustrates a mounting element that attaches the round cutting insert of the present invention to a cutter body while allowing rotation about the insert axis and provides grooves continuous from one end to the other in its outer diameter surface for retention or transmission of grease or cutting fluid.

FIG. 37c illustrates a mounting element that attaches the round cutting insert of the present invention to a cutter body while allowing rotation about the insert axis.

FIG. 37d illustrates a mounting element that attaches the round cutting insert of the present invention to a cutter body while allowing rotation about the insert axis and provides grooves that are not continuous from one end to the other in its outer diameter surface for retention of grease.

FIG. 37e illustrates a mounting element that attaches the round cutting insert of the present invention to a cutter body while allowing rotation about the insert axis and provides grooves continuous from one end to the other in its outer diameter surface for retention or transmission of grease or cutting fluid where the mounting element has an outer sleeve with the grooves and an inner mounting pin.

FIG. 38 illustrates a mounting element and how it attaches the round cutting insert of the present invention to a cutter body while allowing rotation about the insert axis and with the provision of a seal on the outer diameter of the insert.

FIG. 39 shows the design space of the present invention and its two cutter design variables, one on each axis.

FIG. 40 shows various cutters of conventional and tangential mount (per the present invention) within the design space of the present invention.

FIG. 41 shows the method for designing a cutter with tangentially mounted round cutting inserts.

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

### DETAILED DESCRIPTION OF THE INVENTION

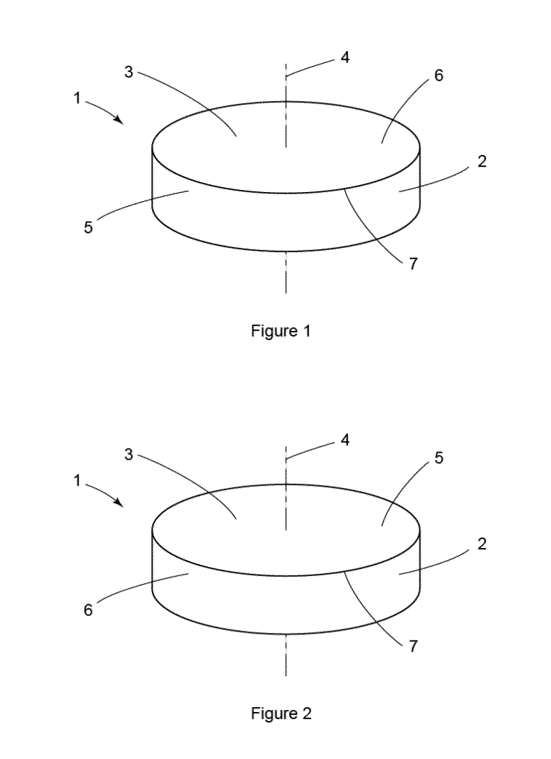

The present invention makes use of one or more round cutting inserts attached to a cutter body. It is best described initially by referring to FIG. 1 where the round Cutting Insert 1 is considered to be a simple disc having Cylindrical Surface 2 and two round Planar Surfaces 3 that are normal to the Insert Axis 4 of the disc (one of the two planar surfaces is not visible in FIG. 1). Still referring to FIG. 1, conventional use of round cutting inserts employs Cylindrical Surface 2 as the flank face, or more generally in this case the Flank Surface 5, and one of the two Planar Surfaces 3 as the rake face, or more generally Rake Surface 6, where the circular intersection of Flank Surface 5 and Rake Surface 6 defines Cutting Edge 7. Referring to FIG. 2, in the present invention, Cylindrical Surface 2 serves as the rake face, or more generally in this case Rake Surface 6, and one of the two Planar Surfaces 3 is the flank face, or more generally Flank Surface 5, where the circular intersection of Flank Surface 5 and Rake Surface 6 defines Cutting Edge 7. The difference is whether Rake Surface 6 is one of the two Planar Surfaces 3 (FIG. 1) or Cylindrical Surface 2 (FIG. 2), the latter being an embodiment of the present invention.

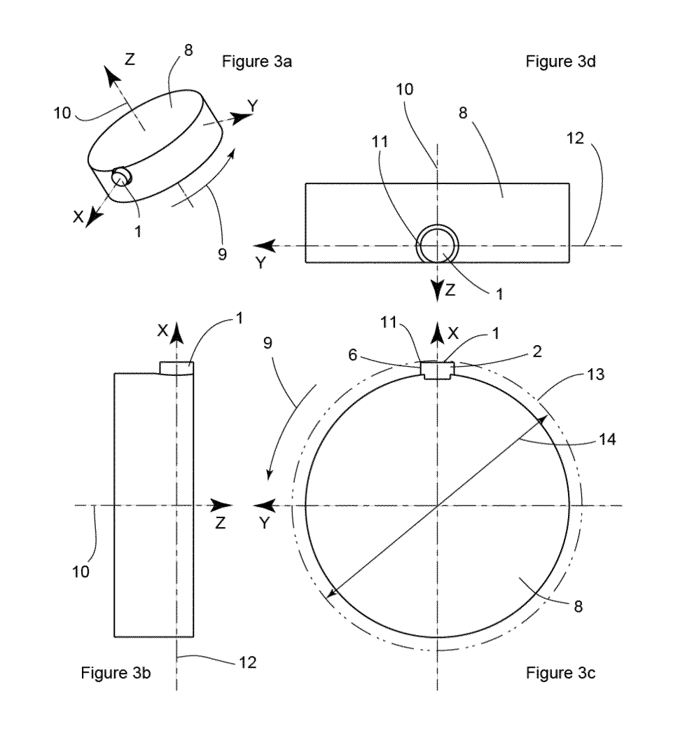

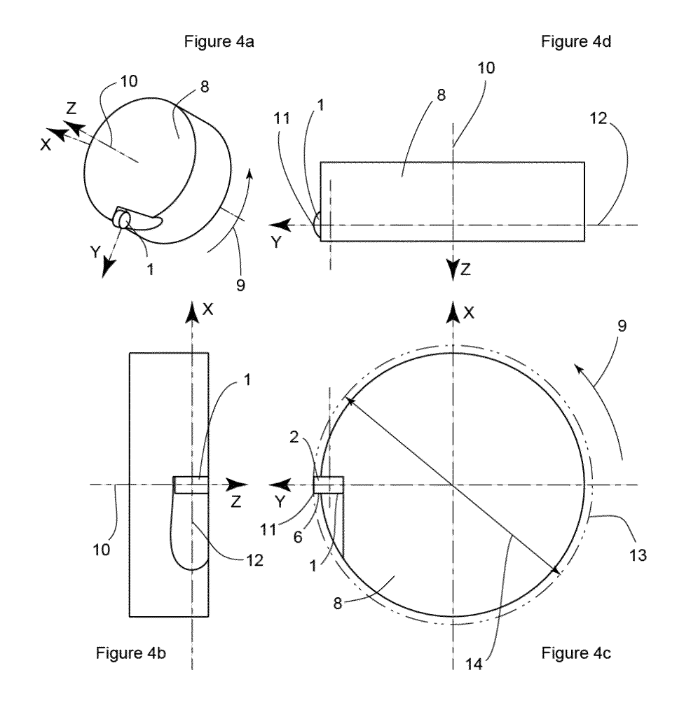

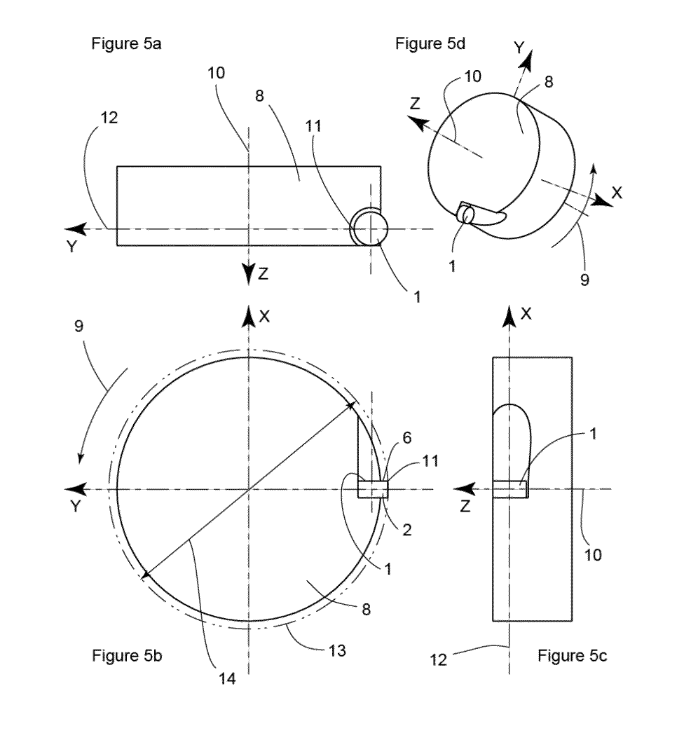

Continuing with the most basic initial description of the present invention, the case of a rotating Cutter Body 8 cutting on its periphery is considered as shown in FIGS. 3a, 3b, 3c and 3d. This basic case is representative of an indexable inserted end mill or slab mill, or in the reduction process industry, a chipper drum, but showing only a single tooth for the sake of clarity; these tools would typically have multiple teeth as noted later. To make use of Cutting Insert 1 as defined in relation to FIG. 2, that is, to make use of the insert's Cylindrical Surface 2 as Rake Surface 6, round Cutting Insert 1 must be tangentially-mounted to Cutter Body 8. This is in contrast to using a conventional round Cutting Insert 1 as defined in relation to FIG. 1 where Cylindrical Surface 2 is Flank Surface 5, as shown in FIGS. 4a, 4b, 4c and 4d. In these figures Cutter Body 8 is rotated in Rotation Direction 9 about Cutter Axis 10 to provide the cutting motion. This represents a right-handed cutter in that the cutter rotation about the Z-axis (Cutter Axis 10) is positive following the right-hand rule where the X-Y-Z coordinate frame is right-handed. The point on Cutting Edge 7 that is furthest outward radially, referred to as the Tooth Tip 11, lies in the Tooth Tip Plane 12 (X-Y plane in this case) and, with cutter rotation, traces Cut Circle 13 of diameter equal to Cutting Diameter 14. In FIGS. 3a, 3b, 3c and 3d Cutting Insert 1 is located and oriented on Cutter Body 8 in what is referred to as the “tangential-mount neutral” state, that is, with the insert axis coincident with the X-axis. FIGS. 4a, 4b, 4c, and 4d, and likewise FIGS. 5a, 5b, 5c and 5d, show the insert in what is referred to here as the “conventional-mount neutral” state.

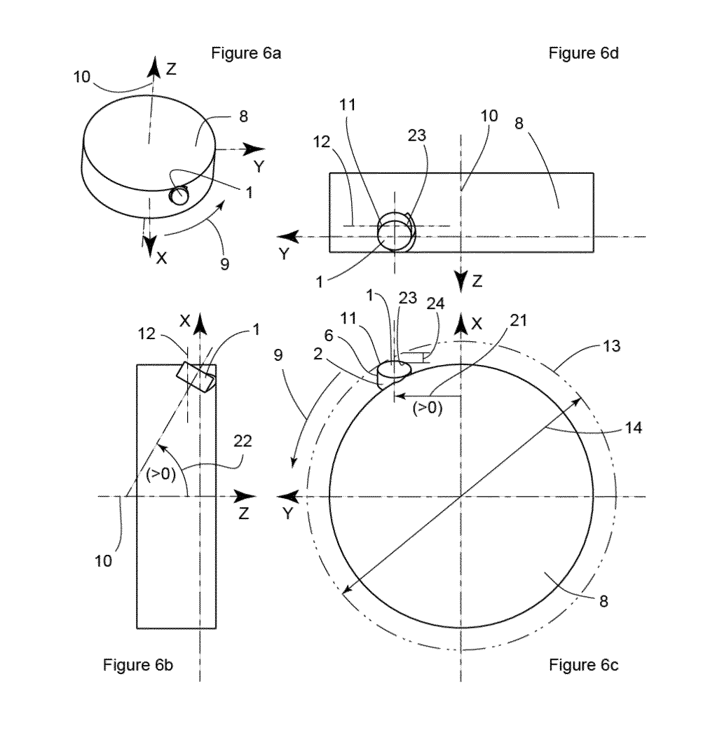

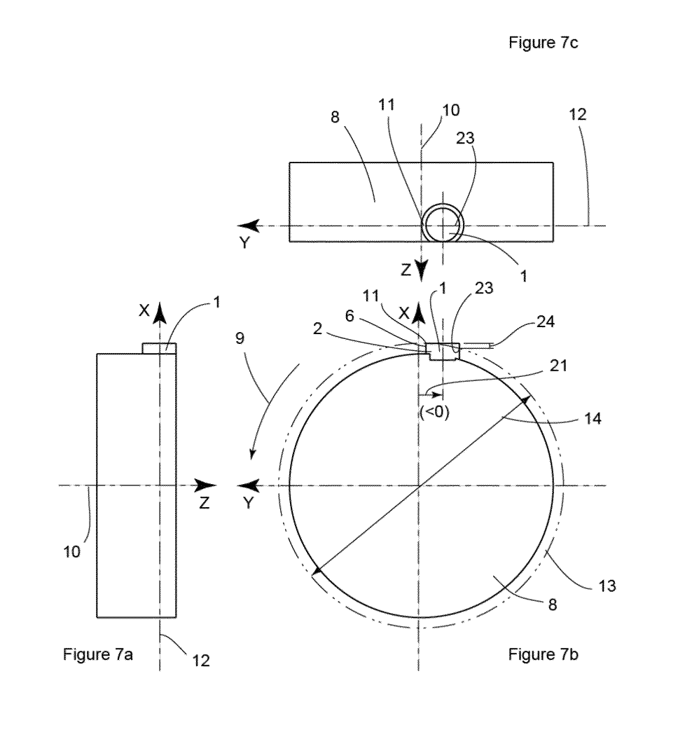

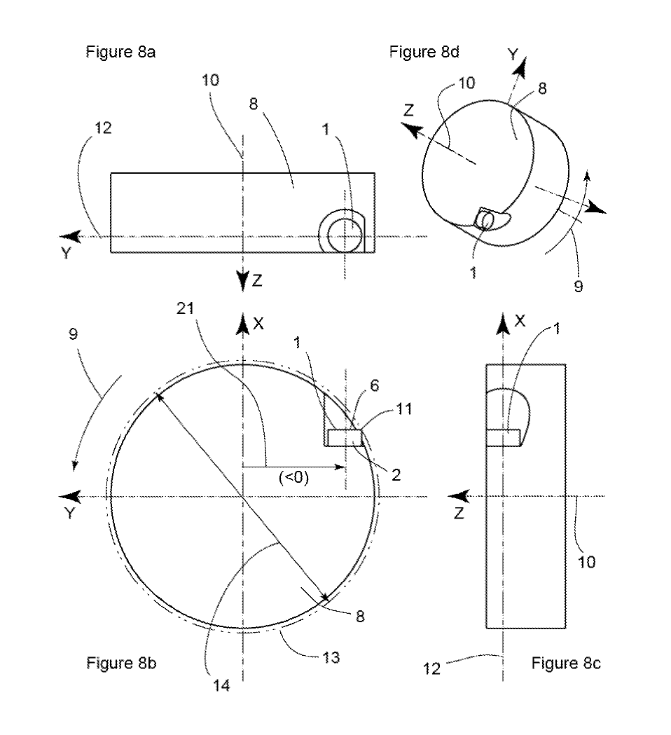

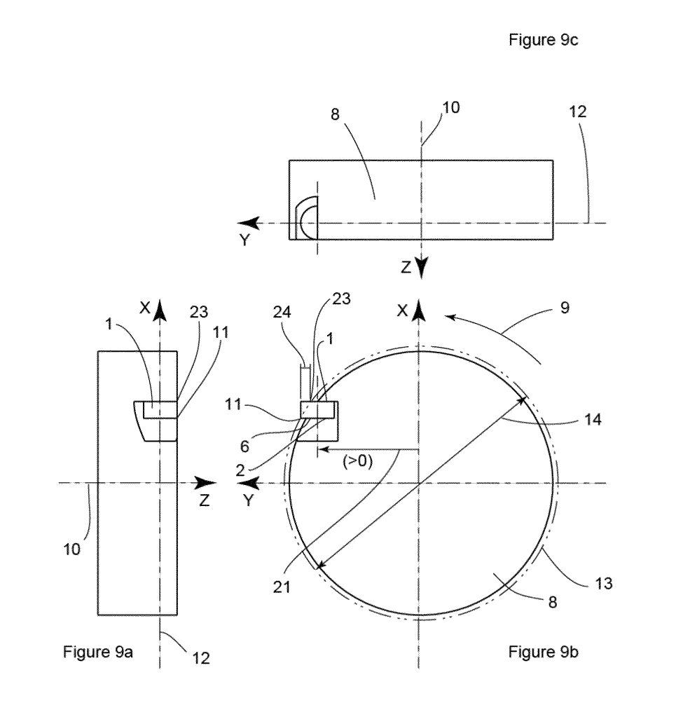

Referring to FIGS. 6a, 6b, 6c and 6d, Cutting Insert 1 is located and oriented on Cutter Body 8 using the two cutter design variables of the present invention—the Reference Plane Offset 21 and the Insert Axis Angle 22. The Reference Plane Offset 21 is measured with respect to the X-Z plane (the reference plane), being positive in the Y-direction. The Insert Axis Angle 22 is the angular orientation of Insert Axis 4, right-hand positive (from the Z-axis toward the X-axis) about the Y-axis. Shown in FIG. 6b is a positive Insert Axis Angle 22 and shown in FIG. 6c is a positive Reference Plane Offset 21 and a positive Trail Edge Clearance 24. FIG. 7b shows the case where the Reference Plane Offset 21 is negative (for simplicity of illustration here, Insert Axis Angle 22 has been set to zero). In this case, Flank Surface 5, or more precisely Edge Trailing Point 23, radially overlaps Cut Circle 13. Edge Trailing Point 23 is the second point on circular Cutting Edge 7 that lies in Tooth Tip Plane 12, the other point on the cutting edge that lies in Tooth Tip Plane 12, as noted, being Tooth Tip 11. The fact that Edge Trailing Point 23 is radially outward of Cut Circle 13 indicates there is not sufficient clearance, or a negative Trail Edge Clearance 24, and there would be unacceptable rubbing on the surface produced by the cutting process. This illustrates that for the present invention, when Insert Axis Angle 22 is zero, Reference Plane Offset 21 must be greater than zero to have positive clearance between Edge Trailing Point 23 and Cut Circle 13, that is, so that Edge Trailing Point 23 falls radially inside Cut Circle 13. The requirement that Reference Plane Offset 21 be greater than zero holds for any Insert Axis Angle 22 between 0° and +180°. Referring back to FIGS. 6c and 6d, it is observed that when Reference Plane Offset 21 is positive, Edge Trailing Point 23 falls radially inside Cut Circle 13, meaning there is positive clearance or, rather, the insert does not rub on the machined surface. Note that for the current illustrative example of cutting on the periphery of this cutter, Insert Axis Angle 22 would likely, without limitation, remain in the range of +60° to +120°. FIGS. 8a, 8b, 8c and 8d illustrate the contrast between the present invention (FIGS. 6a, 6b, 6c and 6d) and a conventional mounting of a conventional round Cutting Insert 1 as defined in relation to FIG. 1 where Cylindrical Surface 2 is Flank Surface 5. FIGS. 9a, 9b, 9c and 9d illustrate the contrast between how clearance is lost in the present invention (FIGS. 7a, 7b, and 7c) when Reference Plane Offset 21 is the incorrect sign and the analogous loss of clearance in a conventional mounting of a conventional round Cutting Insert 1 as defined in relation to FIG. 1 where Cylindrical Surface 2 is Flank Surface 5.

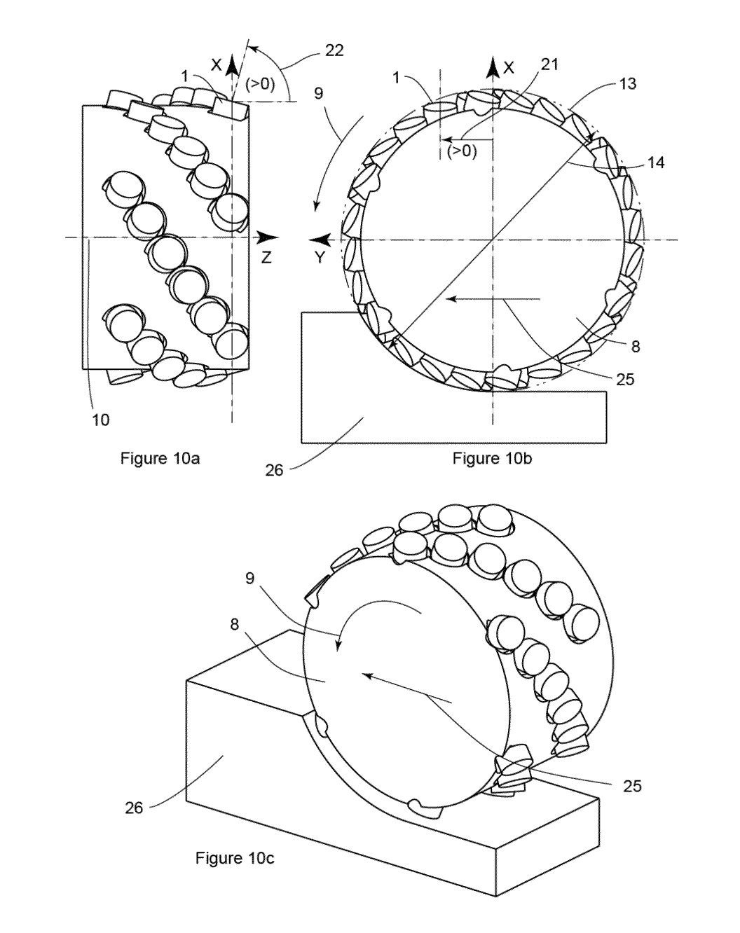

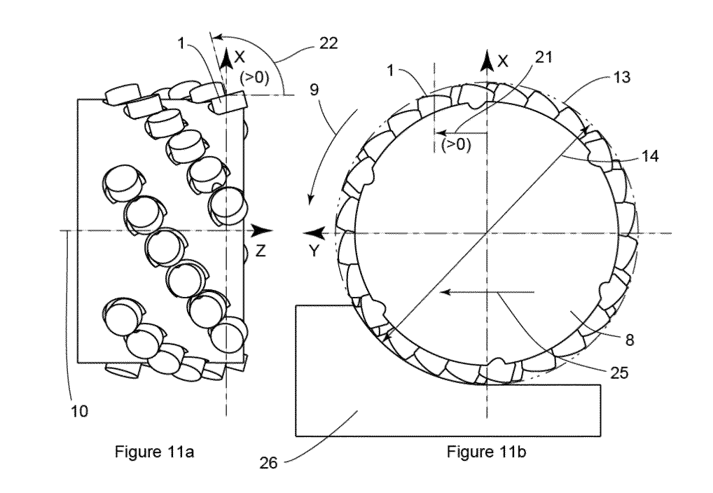

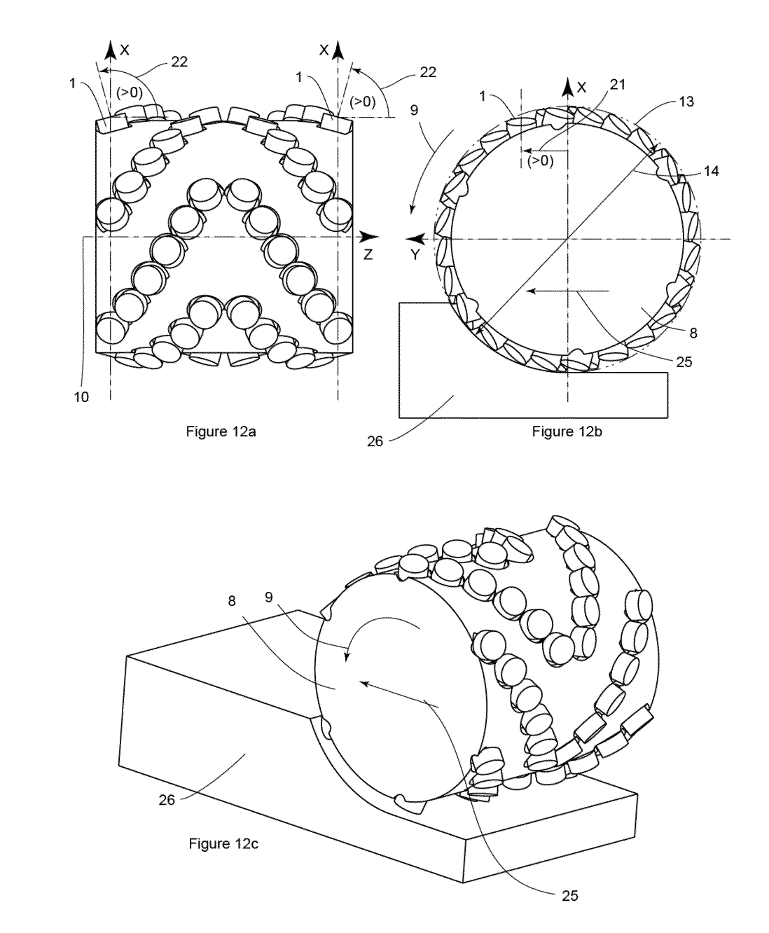

FIGS. 10a, 10b and 10c illustrate a peripheral end mill, slab mill, or chipper drum embodiment. The X-Y-Z axes shown correspond to Cutting Insert 1 that is labeled; each cutting insert would have its own X-Y-Z coordinate frame relative to and in which it is located and oriented. Here, Insert Axis Angle 22 has been set to +75° and the cutter Feeding Motion 25 relative to Workpiece 26 is as shown. FIGS. 11a and 11b illustrate a peripheral end mill, slab mill, or chipper drum embodiment where Insert Axis Angle 22 has been set to +105° and the cutter Feeding Motion 25 relative to Workpiece 26 is as shown. FIGS. 12a, 12b and 12c illustrate a peripheral end mill, slab mill, or chipper drum embodiment where Insert Axis Angle 22 has been set to +75° for one axial region of the cutter, +105° for the remaining axial region of the cutter, and the cutter Feeding Motion 25 relative to Workpiece 26 is as shown. Since two Cutting Inserts 1 are called out in this case for illustration purposes (one at each axial end as shown in FIG. 12a), there are two X-axes shown, one for each insert's coordinate frame (their respective Z-axes are coincident and their Y-axes overlap each other in FIG. 12b). Note that at the location where the axially adjacent teeth having opposing Insert Axis Angle 22 create the vertex of the “V” pattern, the appearance of material that may not be removed is overcome without limitation by means of fine adjustments to how the opposing portions of the “V” pattern are positioned relative to one another in their relative circumferential and axial locations on Cutter Body 8. In all cases (FIGS. 10, 11 and 12 and their subparts), the helical pattern of the teeth can be reversed relative to Rotation Direction 9; the preferred direction of the helix is different depending on the chip formation process mechanics, which are much different in conventional machining processes (for instance machining metal) and reduction processes (for instance wood chipping).

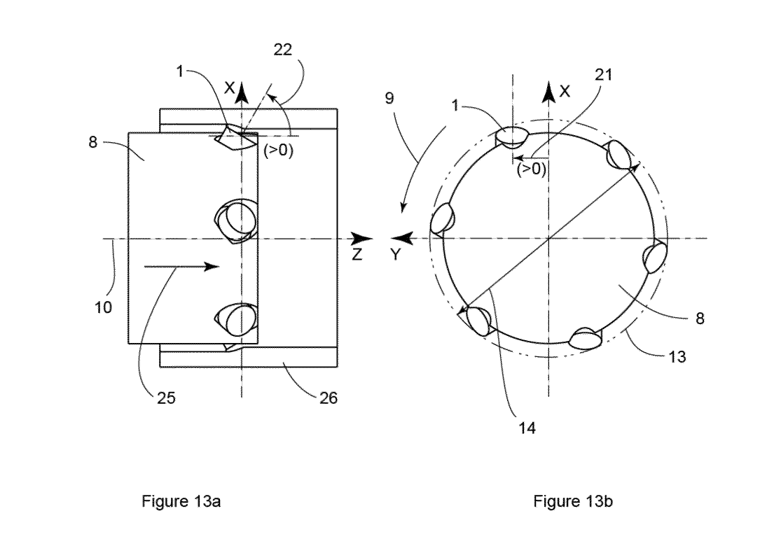

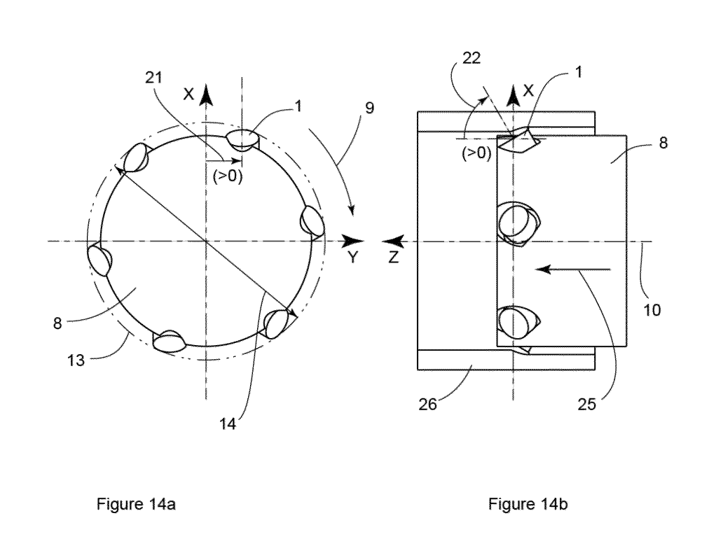

If the present invention were applied to a right-handed cylinder boring tool, Insert Axis Angle 22 would likely, without limitation, fall in the range of +30° to +75°. FIGS. 13a and 13b illustrate this embodiment where, being right-handed, Feeding Motion 25 of the tool into the cylinder that is being enlarged is as shown. If this were a left-handed cylinder boring tool, Insert Axis Angle 22 would fall in the same range as for the right-handed tool, and Reference Plane Offset 21 would still be greater than zero, and all else remains the same with the exception that the X-Y-Z coordinate frame is now left-handed and all other earlier references to “right-handed” would now be “left-handed”. For example, Cutter Rotation 9 would still be about the Z-axis, but positive about Z using the left-hand rule, not the right-hand rule. FIGS. 14a and 14b illustrate this left-handed embodiment.

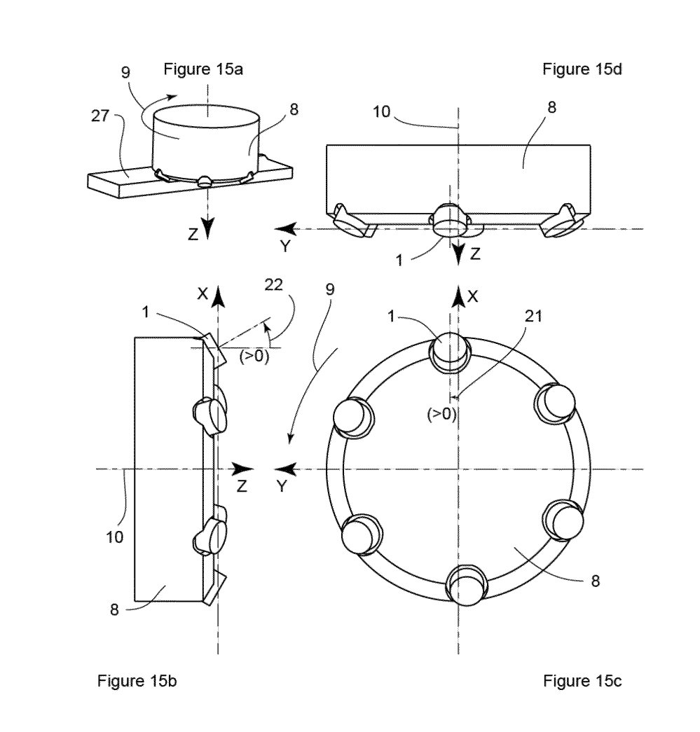

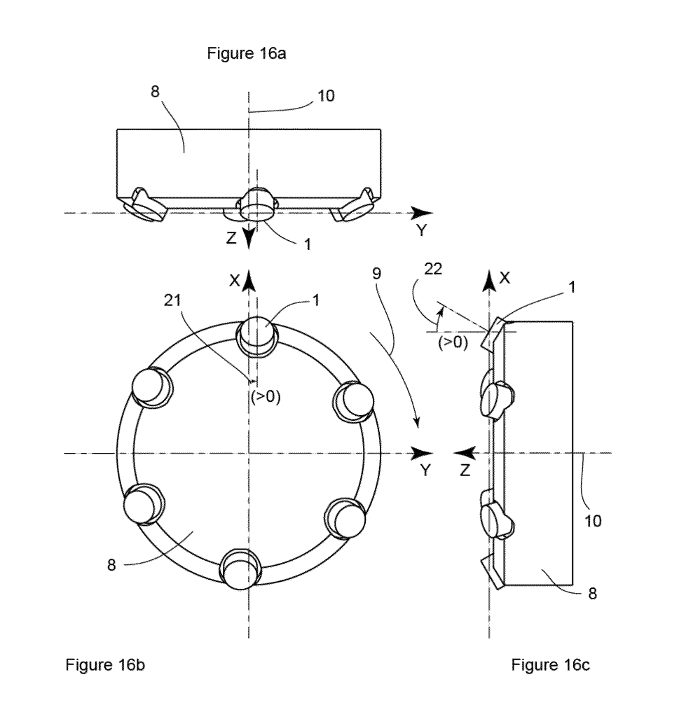

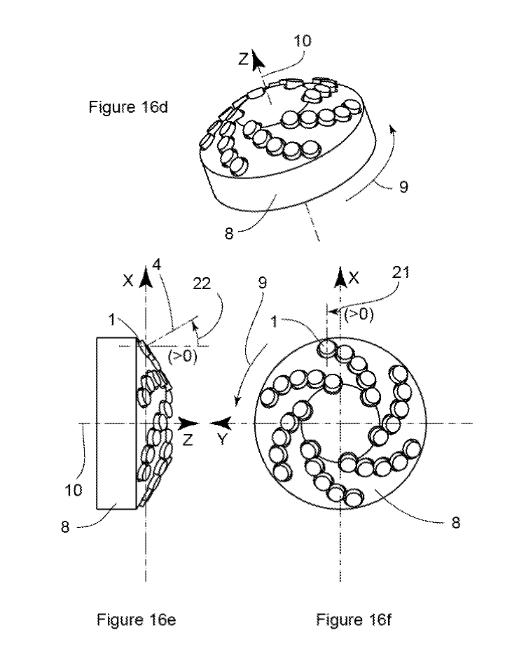

If the present invention were applied to right-handed face milling tool, Insert Axis Angle 22 would likely, without limitation, fall in the range of +15° to +60°. FIGS. 15a, 15b, 15c and 15d illustrate this embodiment where, being right-handed, Feeding Plane 27 is as shown. FIGS. 16a, 16b and 16c illustrate a left-handed face mill embodiment. A face milling tool may have one or more additional sets of cutting inserts, as shown in FIGS. 16d, 16e and 16f, patterned generally up the axial direction and shifted tangentially leading the set shown at the end face of Cutter Body 8. This allows a cutter to accommodate larger axial cutting depths. In this case each additional axial set would generally be shifted outward radially to result in a continuation of a tapered cutting geometry. In some applications this may be referred to as a canting mill or log canting mill.

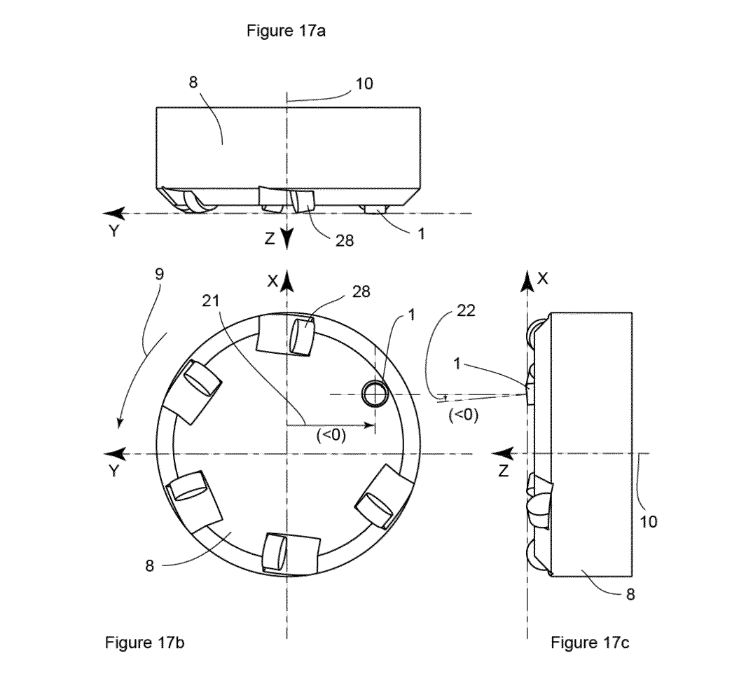

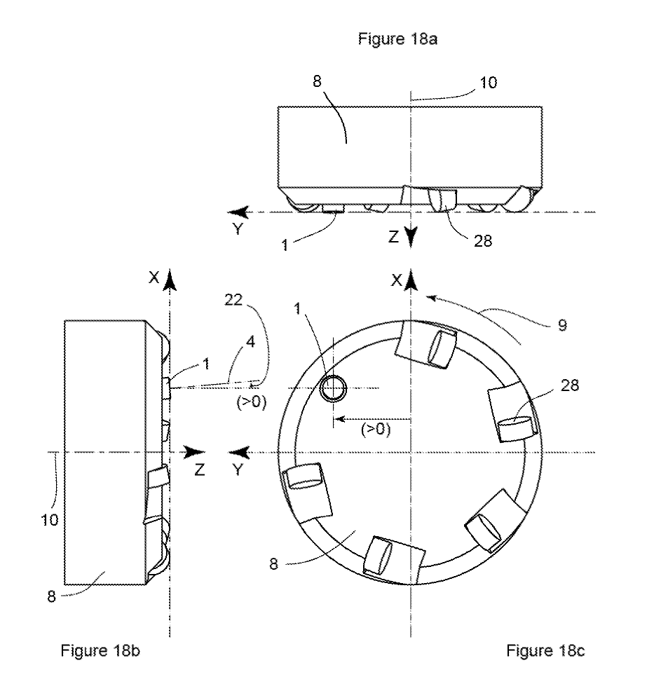

Another embodiment of the present invention as applied to a face milling tool is to use a round cutting insert as a wiper. A wiper is used to remove the small cusps that remain on the machined surface from the primary cutting teeth of a face milling tool. U.S. Ser. No. 14/242,680 describes a “round wiper tooth and face mill incorporating the same.” In the context of the present invention and its two cutter design variables—Reference Plane Offset 21 and Insert Axis Angle 22—the wiper tooth described in U.S. Ser. No. 14/242,680 has a negative Reference Plane Offset 21 and a negative Insert Axis Angle 22. Insert Axis Angle 22 would generally be small, say in the range of −2° to −5°, typically. FIGS. 17a, 17b, and 17c illustrate this embodiment of the present invention as a right-handed face milling tool with five conventionally-mounted round Primary Inserts 28 and one round wiper Cutting Insert 1 that is tangentially mounted per the present invention. This configuration of negative Reference Plane Offset 21, and thus negative Insert Axis Angle 22 as noted earlier to be required to achieve positive clearance anytime the Reference Plane Offset 21 is negative, was specified in U.S. Ser. No. 14/242,680 so as to push the chip produced by the wiper insert (Cutting Insert 1) radially outward relative to Cutter Axis 10. FIGS. 18a, 18b and 18c show an embodiment where Reference Plane Offset 21 and Insert Axis Angle 22 are both positive, in which case the chip formed by the wiper insert (Cutting Insert 1) would flow radially inward relative to Cutter Axis 10. Primary Inserts 28 in FIGS. 17a, 17b, 17c, 18a, 18b and 18c need not be round but could be any other shape mentioned earlier. Primary Inserts 28 could also be tangentially-mounted inserts of round or any other shape mentioned earlier. Primary Inserts 28 in FIGS. 17a, 17b, 17c, 18a, 18b and 18c are shown as conventionally-mounted round inserts for the purpose of illustration without limitation. For instance, a face milling tool or canting mill, either of which may have round wiper inserts, could instead have tangentially-mounted round inserts of the present invention serving as Primary Inserts 28, arranged like those seen in FIGS. 15 and 16 and their subparts (e.g., a, b, c, d).

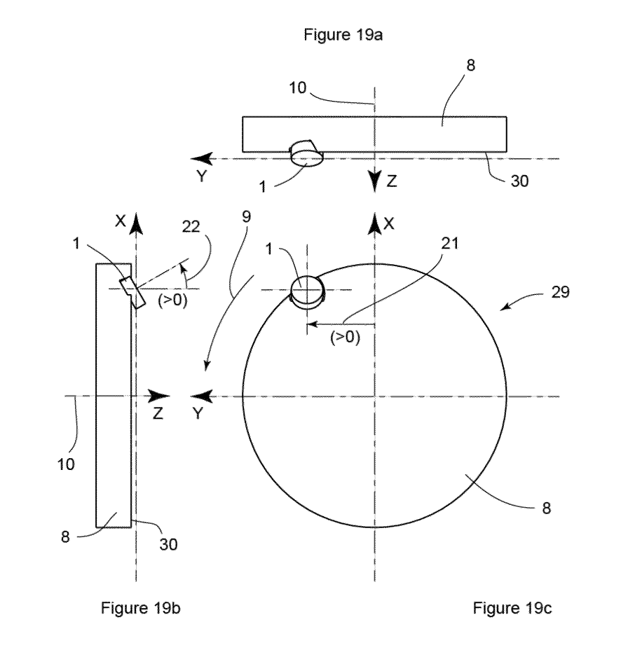

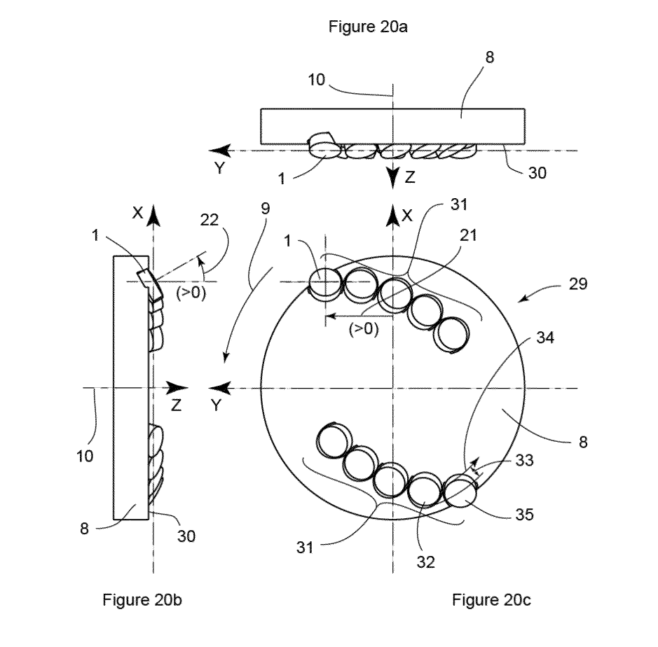

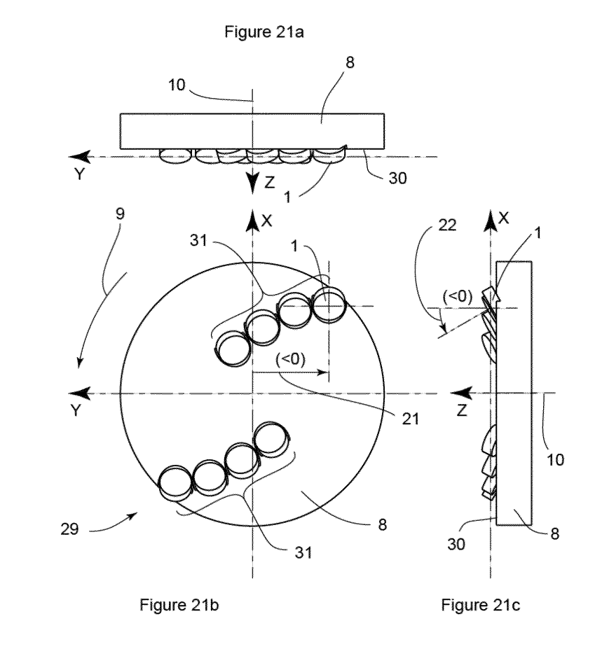

Turning to an application for reduction of feedstock such as woody biomass, a chipper drum was already noted with similarity to a peripheral end mill or slab mill, embodiments of which were shown in FIGS. 10, 11 and 12 and their subparts. An alternative to a drum for use of reduction of feedstock into particles of smaller size is a Chipper Disc 29. A chipper disc would have one or more cutting teeth mounted to Axial Face 30 of the disc. Chipper Disc 29 consists of its Cutter Body 8 and, referring to FIGS. 19a, 19b and 19c, a round Cutting Insert 1 mounted as shown having Reference Plane Offset 21 and Insert Axis Angle 22 both positive. FIGS. 20a, 20b and 20c extend this embodiment to having multiple round teeth, only one of which is called out as the round Cutting Insert 1 in that the X-Y-Z coordinate frame shown is for that specific tooth. In this case and without limitation, there are multiple teeth (five here) that work together as a Tooth Set 31, and then multiple (two here) tooth sets. The arrangement in this figure shows how a Subsequent Tooth 32 in a Tooth Set 31 is positioned to have a significant Overlap 33 with the Cutting Path 34 of the tangentially Preceding Tooth 35 (tangentially preceding relative to Cutting Rotation 9) so that it cuts with only a portion of the insert diameter. This general shadowing of a tooth by the tangentially Preceding Tooth 35 is also seen (though not illustrated in, nor discussed in reference to) the end mill, slab mill and chipper drum embodiments displayed in FIGS. 10, 11 and 12 and their subparts. In the embodiment shown in FIGS. 20a, 20b and 20c, the chips would, relative to Cutter Axis 10, form on the radially inward portions of each cutting insert and flow radially inward. The embodiment shown in FIGS. 21a, 21b and 21c reverses the sequence of each tooth in each Tooth Set 31, each Tooth Set 31 having only four teeth in this case, so that cutting occurs, relative to Cutter Axis 10, on the radially outward portion of each cutting insert and causing chips to flow radially outward. Either embodiment may have advantages in various situations. In FIGS. 21a, 21b and 21c, Reference Plane Offset 21 and Insert Axis Angle 22 are both negative. In FIGS. 20a, 20b and 20c, Reference Plane Offset 21 and Insert Axis Angle 22 are both positive. It is also noted that, without loss of generality, any reference to a “chipper” for woody biomass can apply as a “chopper” for grassy biomass or any other commonly used term for a cutter used to reduce into smaller particles larger feedstock of woody biomass, grassy biomass or other materials mentioned earlier in the background section.

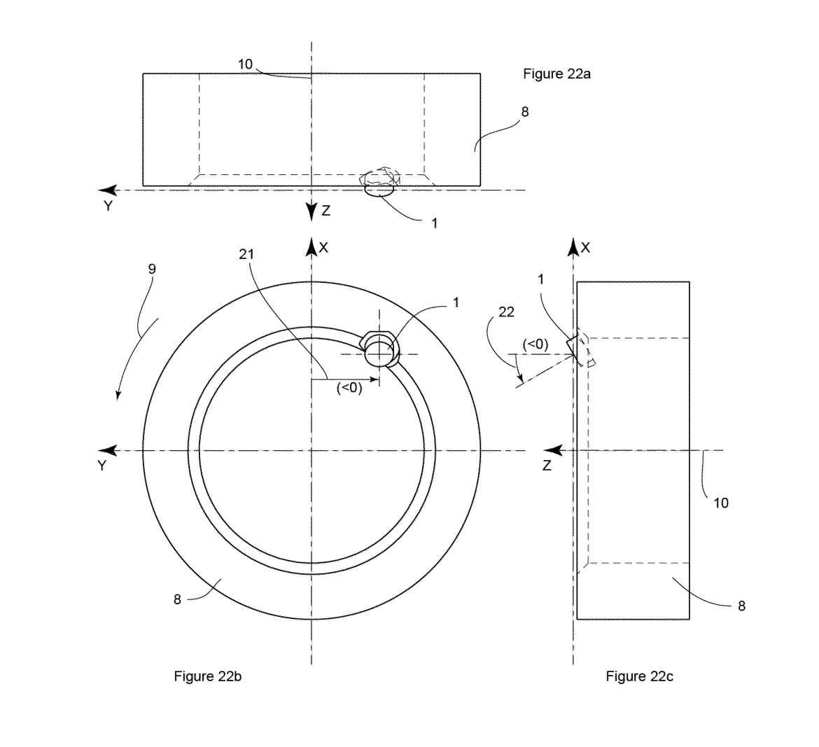

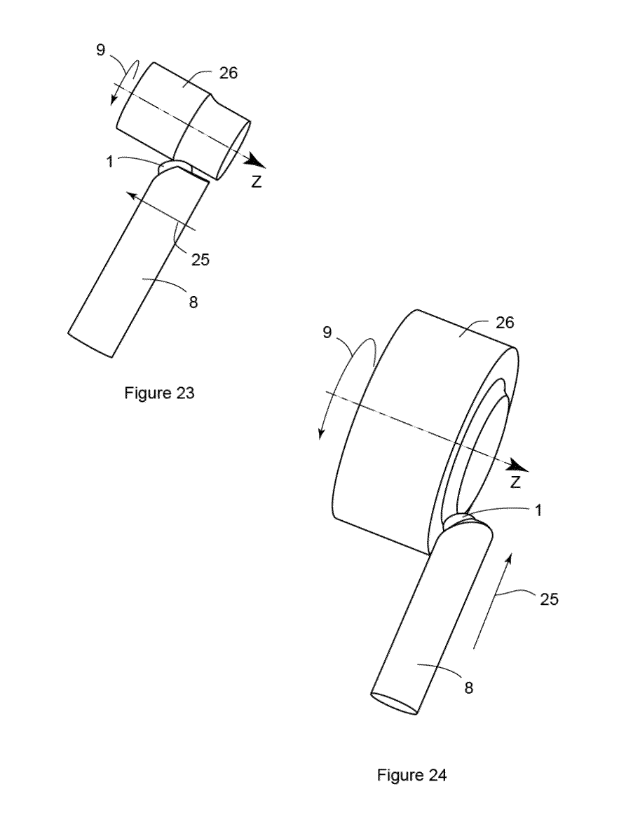

Returning to a conventional machining process, a lathe turning process may employ the present invention. FIGS. 22a, 22b and 22c show an abstract extension of the present invention as an inverted cylinder boring tool, that is, where a Cutting Insert 1 is tangentially mounted at the inner diameter of Cutter Body 8 (now a tube rather than a bar) with Reference Plane Offset 21 and Insert Axis Angle 22 both being negative; Insert Axis Angle 22 is shown to be about −30° but would likely, without limitation, fall in the range of −30° to −75°. If this tool were provided a feeding motion along its Z-axis Cutting Insert 1 would remove material from the outer diameter of coaxially located bar feedstock. Generally, a turning operation is not performed with a tool of this physical structure; it is shown as a means of illustrating how the cuter design variables are used to define a lathe turning tool in relation to and extension from previously discussed embodiments for cylinder boring tools and face milling tools. FIG. 23 shows an actual embodiment of a lathe turning tool having Feeding Motion 25 (of the tool) and cutting on the outer diameter of Workpiece 26 being rotated about the Z-axis in Rotation Direction 9. FIG. 24 shows an embodiment of the present invention being used as a lathe facing tool having Feeding Motion 25 (of the tool) and cutting on the end face of Workpiece 26 being rotated about the Z-axis in Rotation Direction 9.

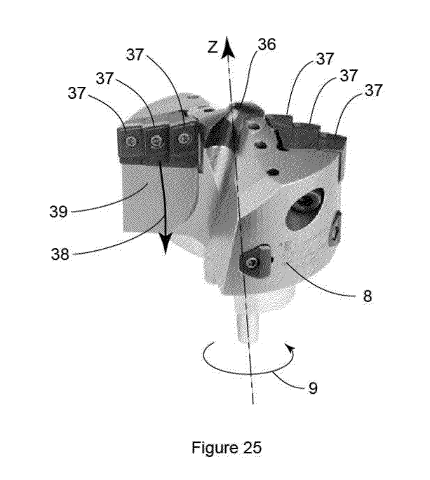

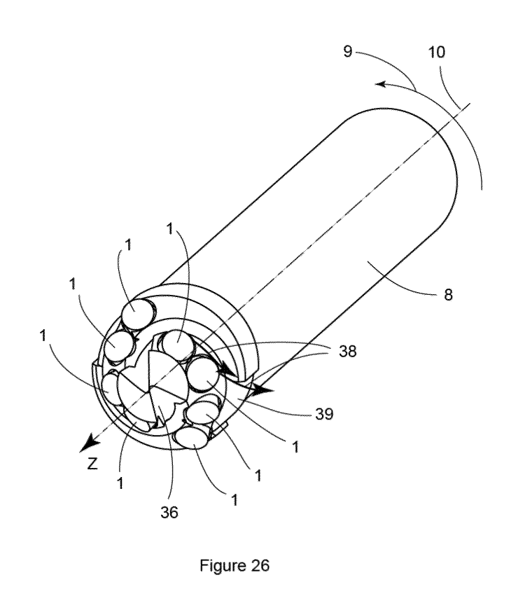

Another conventional machining process of interest with the present invention is drilling. Drills are used to create a hole where a hole did not previously exist. Under the present invention, a drill (or drill bit) may be outfitted with tangentially-mounted round cutting inserts to perform the majority of the cutting, but would require a central cutting element that is seen in current products in order to provide cutting in the central region of the hole. FIG. 25 shows an example of an indexable insert drill currently available in the marketplace that exhibits Central Cutting Element 36 and one or more Cutting Lip Inserts 37 (three on each of the two cutting lips in this example). Chips formed by Culling Lip Inserts 37 flow ahead of the inserts (relative to the tangential cutting motion) in Chip Flow 38 direction up Flute 39 and out of the hole being created by the drill. FIG. 26 shows how the present invention may be applied to replace Cutting Lip Inserts 37 with Cutting Inserts 1 per the present invention (2 sets of 4 each). In this case, chips will flow generally to behind each Cutting Insert 1 and, thus, up Flute 39 behind (relative to the tangential cutting motion) the Cutting Insert 1 rather than ahead (relative to the tangential cutting motion) of Cutting Lip Inserts 37 (see FIG. 25).

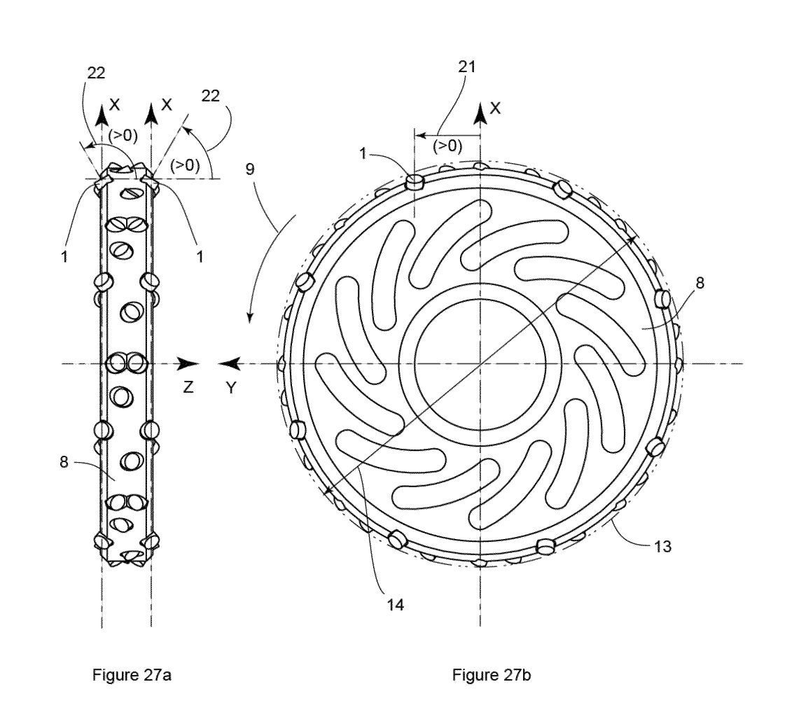

A final process/cutter embodiment of the present invention can provide a circular saw with tangentially-mounted round inserts. This is shown in FIGS. 27a and 27b. The figures illustrate the general nature of tooth patterning but are not to prescribe or impose limitations on any specific tooth patterning. In these figures, two Cutting Inserts 1 are called out, each having their respective and different Insert Axis Angle 22, though both are positive (without limitation, one being about 60° and the other about 120°). The two Cutting Inserts 1 that are called out have different coordinate frames, where the Z-axes are coincident and the different Y-axes lie on top of one another in FIG. 27b.

Thus far the round cutting inserts have been shown as simple discs for the purpose of illustration. All embodiments would make use of specific round insert geometry features that are part of the present invention. These geometry features of the present invention allow the round cutting inserts, when mounted tangentially, to perform with the greatest strength and utility. Each of the following figures include both a three-dimensional and cross-section view to best illustrate the various embodiments of the tangentially-mounted round Cutting Insert 1.

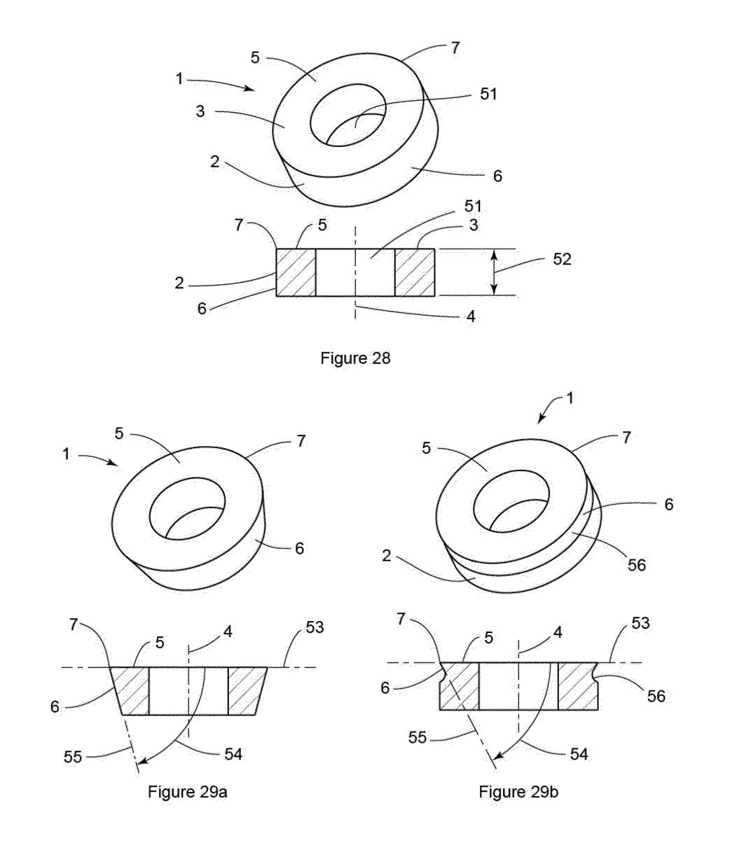

First, for mounting purposes, Cutting Insert 1 of the present invention would have a Central Hole 51 as shown in FIG. 28. Also shown is the Insert Thickness 52.

Next, since the tangential mounting of a round cutting insert requires in many embodiments that Reference Plane Offset 21 be positive, the normal rake angle associated with a round cutting insert as shown in FIG. 28 would be negative. As Reference Plane Offset 21 becomes more positive, the normal rake angle would become more negative. As Insert Axis Angle 22 changes such that Insert Axis 4 deviates further from being normal to Feeding Motion 25 or Feed Plane 27, the normal rake angle is also made more negative. Negative normal rake angle generally results in less favorable chip formation mechanics. To alleviate this, material may be removed from Cylindrical Surface 2 so that the included angle between Axial Flank Plane 53 and the plane that is tangent to Rake Surface 6 (the Rake Surface Tangent Plane 55) is less than 90° as shown in FIG. 29a. This angle is referred to as the Rake Surface Tangent Angle 54 and is denoted as δ. When the rake surface is not simply conical as it is in FIG. 29a, Rake Surface Tangent Angle 54 is the angle between Axial Flank Plane 53 and the plane that is tangent to Rake Surface 6 at and containing a point on circular Cutting Edge 7. FIG. 29b shows an embodiment where only a small amount of material has been removed from Cylindrical Surface 2, still resulting in δ<90° (Rake Surface Tangent Angle 54). The size and overall cross-sectional shape of Rake Surface Groove 56 in FIG. 29b is arbitrary so long as the tangent to its cross-sectional shape at its intersection with Flank Surface 5, which defines circular Cutting Edge 7, yields δ<90° (Rake Surface Tangent Angle 54). In some embodiments, such as but not limited to when machining or reducing very brittle materials, it may be desired to have a more negative normal rake angle than results from the chosen combination of Reference Plane Offset 21 and Insert Axis Angle 22; in this case material may be added to Cylindrical Surface 2 yielding δ>90° (Rake Surface Tangent Angle 54).

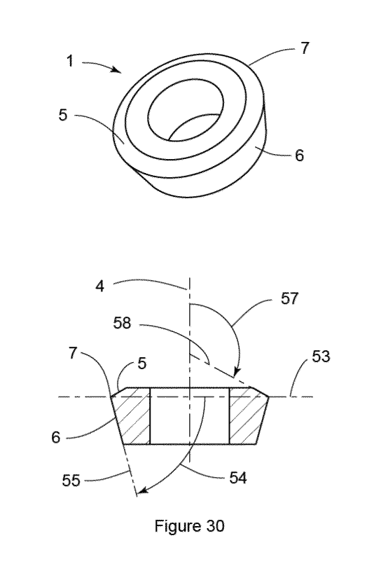

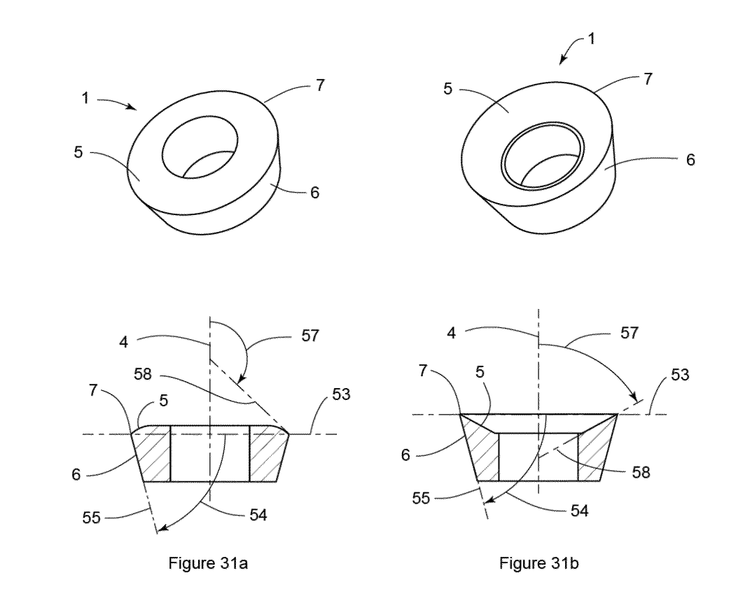

When ample flank clearance is available, the insert may be strengthened by adding material on Planar Surface 3 on the flank side of circular Cutting Edge 7 resulting in Flank Surface 5 being conical. The included angle between Insert Axis 4 and the plane that is tangent to Flank Surface 5 is greater than 90° as shown in FIG. 30. Flank Surface Tangent Angle 57 is denoted as β. It is the angle between Insert Axis 4 and the tangent to Flank Surface 5 (the Flank Surface Tangent Plane 58) at and containing a point on circular Cutting Edge 7. The size and overall cross-sectional shape of Flank Surface 5 is arbitrary so long as the tangent to its cross-sectional shape at its intersection with Rake Surface 6, which defines circular Cutting Edge 7, yields β>90° (Flank Surface Tangent Angle 57). An example is shown in FIG. 31a where Flank Surface 5 is curved, not conical. In some embodiments, it may be desired to have more clearance immediate the circular Cutting Edge 7; in this case material may be removed from Planar Surface 3 on the flank side of circular Cutting Edge 7 yielding β<90° (Flank Surface Tangent Angle 57) as shown in FIG. 31b.

To summarize, a neutral insert of the present invention as shown in FIG. 28 has δ=90° and β=90°, but to provide more favorable performance other embodiments may exhibit a non-cylindrical Rake Surface 6 near to circular Cutting Edge 7 such that δ>90° or δ<90° and a non-planar Flank Surface 5 near to circular Cutting Edge 7 such that β>90° or β<90°.

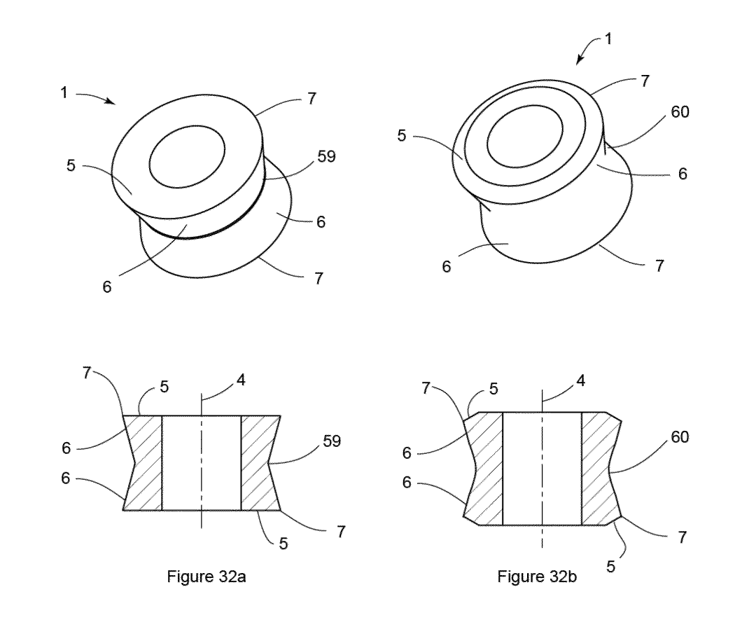

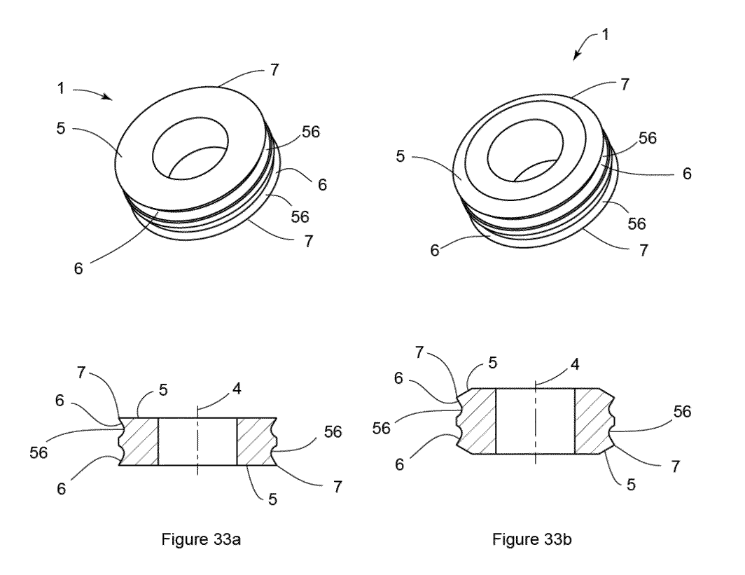

In many cases it is more economical to configure a cutting insert so that it may be flipped over, meaning in this case it has a second circular Cutting Edge 7 where the second Planar Surface 3 intersects Cylindrical Surface 2. FIG. 32a shows how the embodiment of FIG. 29a can be made to have two circular Cutting Edges 7. The two opposing conical Rake Surfaces 6 may meet at a practically Sharp Vertex 59 as in FIG. 32a or have a Geometric Blend 60 where they meet as shown in FIG. 32b. FIG. 32b shows how the embodiment of FIG. 30 can be made to have two circular Cutting Edges 7. FIG. 33a shows how the embodiment of FIG. 29b can be made to have two circular Cutting Edges 7 by creating two Rake Surface Grooves 56. FIG. 33b shows that same embodiment with added material on the flank side of both circular Cutting Edges 7 derived from the embodiment in FIG. 30. The relative diameters and thicknesses of the various illustrations are arbitrary and not limiting.

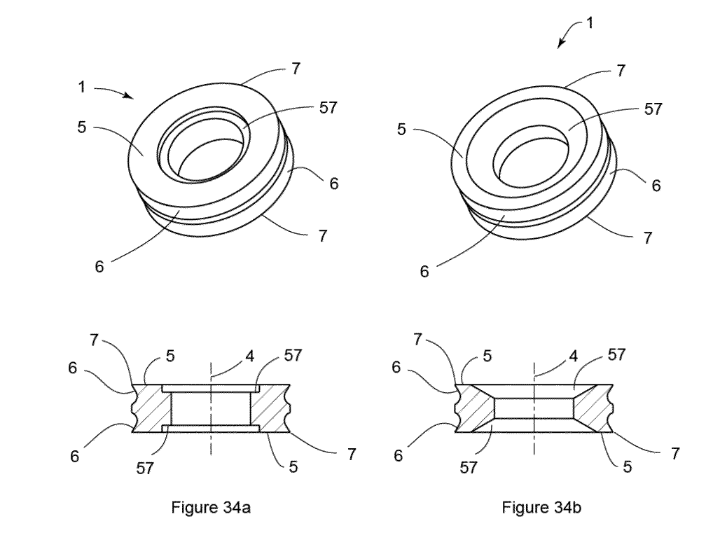

Shown in FIGS. 34a and 34b is Mounting Element Recess 57. In FIG. 34a, it is shown as a counter-bore. This provides a place for the mounting element to recess fully or partially into the insert so as to avoid protruding too much, which would cause it to gouge into the workpiece. The mounting element may be, for instance, a threaded fastener where the head of the fastener would recess into Mounting Element Recess 57 and the threaded end would be threaded into Cutter Body 8. FIG. 34b shows that Mounting Element Recess 57 may have other axisymmetric shapes, such as that of a countersink or other series of conical surfaces.

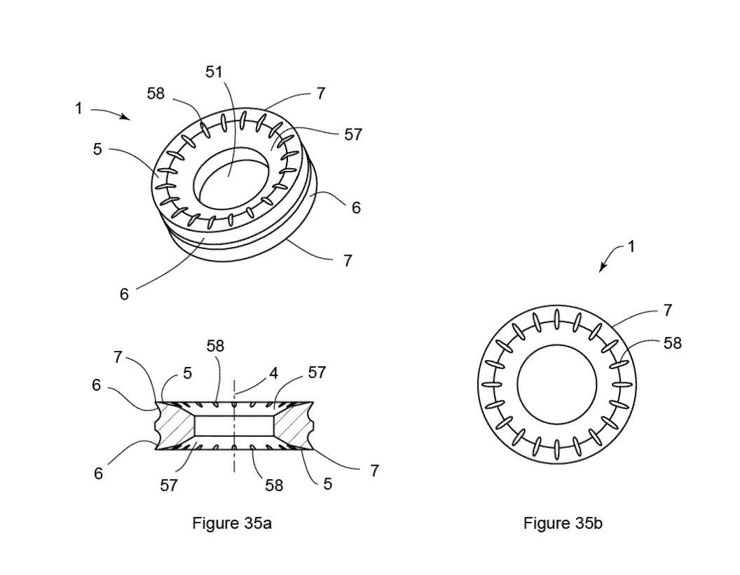

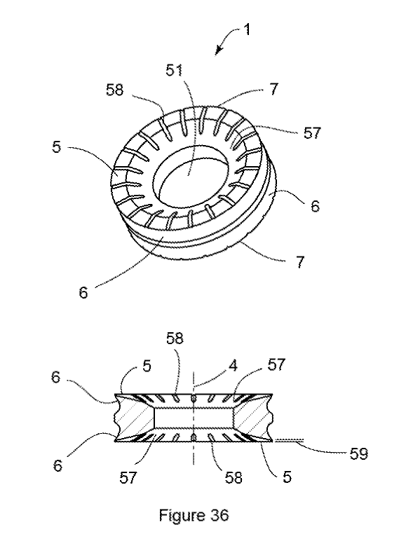

Building on FIG. 34b as an example but without limitation, shown in FIG. 35a is one or more small Flank Grooves 58 running radially outward from Mounting Element Recess 57. Flank Grooves 58 serve as passages for coolant to spray into the clearance space between Flank Surface 5 and the surface produced by the cutting away of material by Cutting Edge 7. The coolant in this case would pass through Central Hole 51, to reach Flank Grooves 58. In this case the coolant would pass through space provided between the inner diameter wall of Central Hole 51 and either the outer diameter of the mounting element that is sized to be smaller than the diameter of Central Hole 51 or other geometry (noted later) integrated into the mounting element. FIG. 35b shows how Flank Grooves 58 stop radially inward from Cutting Edge 7 so as not to pass through Cutting Edge 7 which would create gaps in Cutting Edge 7. As shown in FIG. 36 Flank Grooves 58 may alternatively extend to and through Cutting Edge 7. In this case, if Flank Groove Depth 59 measured at Cutting Edge 7, as projected into the uncut chip thickness of the material being removed is greater than the uncut chip thickness of the material being removed, the chip width will be split into two or more pieces. This is of great utility in embodiments to be discussed next where round Cutting Insert 1 is mounted to Cutter Body 8 in a way that allows it to rotate under the forces of chip formation. When it rotates, the gaps in circular Cutting Edge 7 rotate through the cutting zone causing an otherwise long chip to be segmented into shorter pieces. This is favorable in conventional machining processes for workpiece materials that naturally form long chips (e.g., steel, nickel alloys, titanium) that are difficult to dispose of and remove from the workspace.

As noted in the background section, some applications may benefit from allowing the tangentially-mounted round Cutting Insert 1 to rotate about its Insert Axis 4. Due to the level of immersion of a Cutting Tooth 1 of the present invention into the material being machined (see FIGS. 15a, 23 and 24, for example), or in other cases the way adjacent teeth are patterned so that each Subsequent Tooth 32 cuts in the shadow of or having Overlap 33 with Cutting Path 34 of its tangentially Preceding Tooth 35 (see FIG. 20c, for example), the chip formation contact with each Cutting Tooth 1 under the present invention generally occurs significantly or at least centered to one side of its Insert Axis 4. As such, the tendency for each Cutting Insert 1 to rotate about its Insert Axis 4 is strong and will occur as long as the method of mounting Cutting Insert 1 to Cutter Body 8 constrains Cutting Insert 1 relative to Cutter Body 8 in all degrees of freedom with the exception of one—the rotational degree of freedom about Insert Axis 4.

To allow rotation about Insert Axis 4, something is needed other than a threaded fastener or the like that axially clamps Cutting Insert 1 to Cutter Body 8. A threaded fastener may be used, but in such a way that it does not axially clamp Cutting Insert 1, that is, it does not apply significant axial force that results in significant friction that would resist the desired rotational motion about Insert Axis 4.

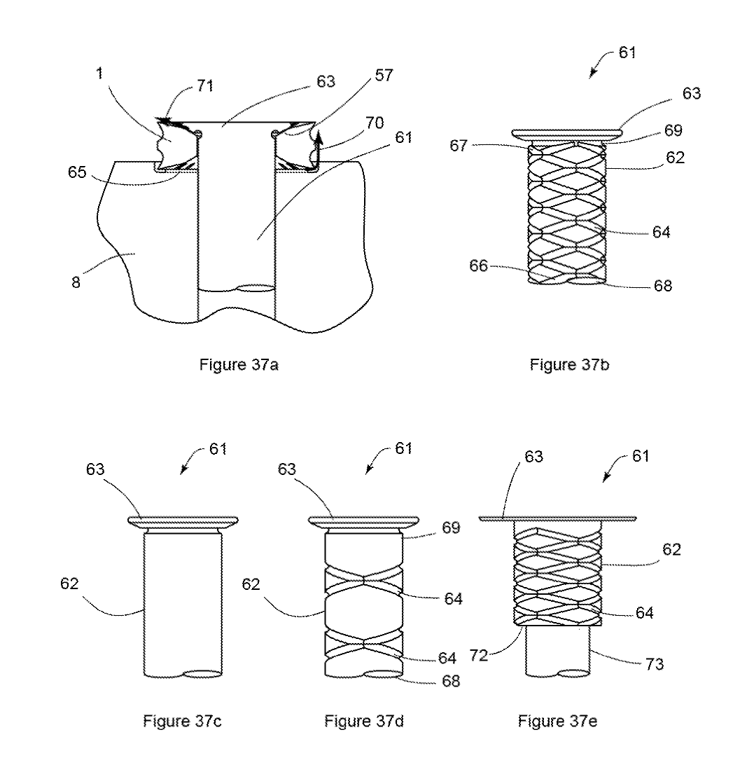

FIG. 37a shows how Cutting Insert 1 is mounted to Cutter Body 8 with Mounting Element 61. In this case of allowing Cutting Insert 1 to rotate, Mounting Element 61 serves as the “stator” (stationary) or axle and Cutting Insert 1 is the “rotor” (rotating). FIG. 37b shows how Mounting Element 61 always includes Outer Diameter Surface 62 (see FIG. 37b), which mates with the inner diameter surface of Central Hole 51 on Cutting Insert 1 in a clearance fit appropriate to the level of precision needed in the surface produced by the tool and the level of precision Central Hole 51 and Outer Diameter Surface 62 can be cost-effectively manufactured. Mounting Element 61 also includes a Retaining Head 63 that seats inside Mounting Element Recess 57 to restrain Cutting Insert 1 in its axial direction relative to Cutter Body 8, but in such a way as to not clamp down axially as noted, which would otherwise induce a frictional resistance to prohibit rotation. Under Cutting Insert 1 is a Thrust Seat 65 which can be of a low friction material and replaced periodically as it wears.

The embodiment of Mounting Element 61 in FIG. 37a would have Passages 64 on Outer Diameter Surface 62, but for clarity they are not shown in this view; FIG. 37b shows this embodiment where one or more Passage 64 are included on Outer Diameter Surface 62. Each Passage 64 without limitation may be helical as shown, or strictly axial, with the only requirement being that each Passage 64 continuously communicates from Lower Passage End 66 to Upper Passage End 67, Lower Passage End 66 being remote to Lower Element End 68 and Upper Passage End 67 being remote to Upper Element End 69. Each Passage 64 serves as a reservoir for lubricant or, in some uses, a passage for cutting fluid that serves as a lubricant and coolant to both the rotating interface between Central Hole 51 and Outer Diameter Surface 62 as well as, by way of expulsion of the cutting fluid, coolant to the cutting process itself. Passages 64, extending down to Lower Element End 68, would allow cutting fluid to be transmitted from a supply below Lower Element End 68 to an exhausting of Rake Face Coolant 70, Flank Face Coolant 71 that passes through Flank Grooves 58, or both.

FIG. 37c shows an embodiment of Mounting Element 61 that has no Passages 64. FIG. 37d shows an embodiment of Mounting Element 61 with one or more Passages 64 that do not continuously communicate from Lower Element End 68 to Upper Element End 69. This embodiment may be useful when only lubricant (no cutting fluid transmission desired) is used and forces exist that may tend to push the lubricant toward one axial end or the other of Mounting Element 61, such as on chipper drum applications where very high rotational speed (relative to the Cut Diameter 14) are present which results in centrifugal forces acting on the lubricant. FIG. 37e shows an embodiment where Mounting Element 61 is two pieces, one being a Sleeve 72 and the other being the Fastener 73. Fastener 73 may be a threaded fastener or a pin with a head at Upper Element End 69 and geometric features as attachment provisions below Lower Element End 68. In any case Fastener 73 provides the attachment of Sleeve 72 to Cutter Body 8 as well as the aforementioned function of Retaining Head 63. In this embodiment, Sleeve 72 serves the purpose of the appropriate clearance fit to the inner diameter of Central Hole 51 and may or may not have one or more Passages 64. This two-piece Mounting Element 61 is useful in cases where Central Hole 51 is relatively large and the cost of periodically replacing a large one-piece Mounting Element 61 due to wear is higher than replacing only Sleeve 72 in a two-piece embodiment. This can also be cost effective in smaller applications depending on the manufactured cost of Outer Diameter Surface 62 and Passages 64 relative to the manufactured cost of other features that are not part of this invention that relate to affixing Mounting Element 61 or, alternatively Fastener 73, to Cutter Body 8.

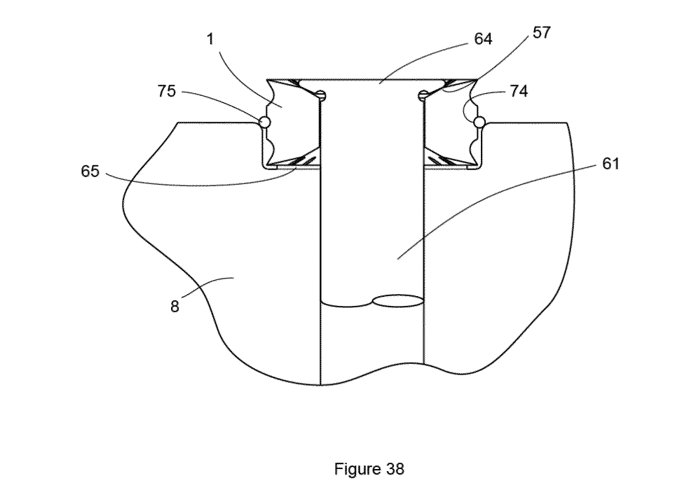

As shown in FIG. 38, for situations where cutting fluid is not used or cutting fluid is used but Rake Face Coolant 70 is not desired, Cutting Insert 1 of any previously shown embodiment may have a Seal Groove 74 in which a Seal 75, such as but not limited to an O-ring, may be retained to mate with Cutter Body 8 to resist infiltration of foreign particles into the rotating interfaces.

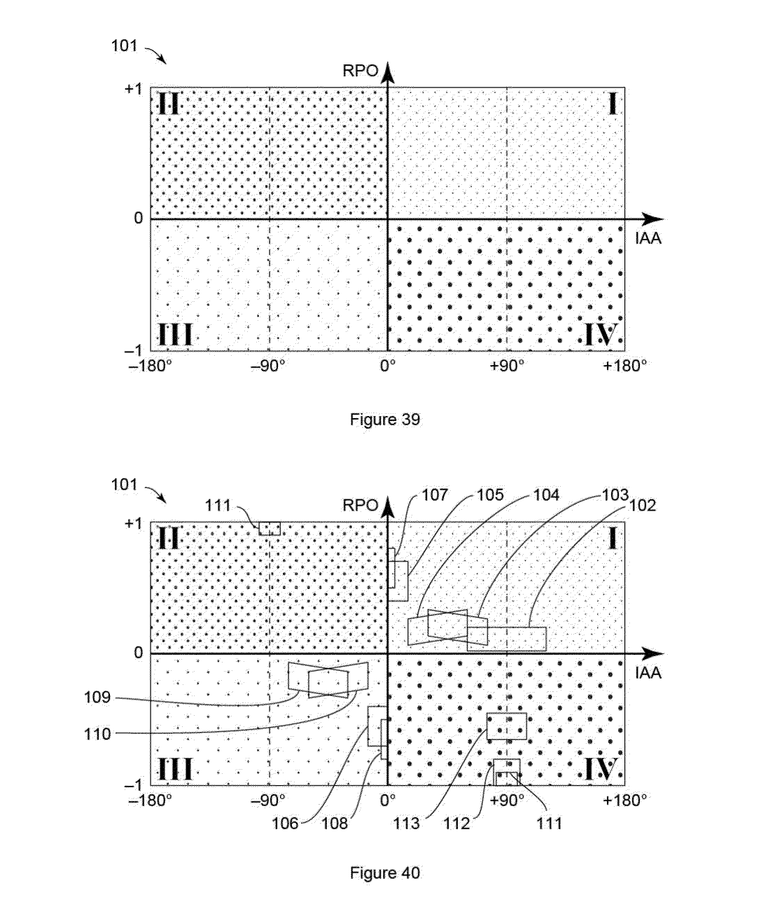

The final aspect of the present invention is the method of designing tools for tangentially-mounted round cutting inserts. FIG. 39 shows the Design Space 101 for the two cutter design variables—Reference Plane Offset 21 and Insert Axis Angle 22. These are, respectively, identified on the vertical axis as “RPO” and the horizontal axis as “IAA”. IAA may range from—180° to +180°. RPO may range from −1 (see FIG. 5 for an example) to +1 (see FIG. 4 for an example) and, in this definition, is unitless or nondimensional. At either extreme of −1 or +1 the insert mounting can only be conventional. RPO is related to the corresponding dimensioned value (that is, in millimeters or inches, for example) of Reference Plane Offset 21 by the relation

$$R P O = \frac{Reference Plane Offset ( in mm or inch )}{\frac{1}{2} [ {D}_{c} - ( {D}_{c} - \sqrt{{D}_{c}^{2} - {T}_{i}^{2}} ) - {D}_{i} ]} ,$$

where D_{c} is Cut Diameter 14, Dᵢ is the diameter of the circular Cutting Edge 7, and Tᵢ is Insert Thickness 52, all three of which are in the same units as Reference Plane Offset 21 in the numerator. In FIG. 39, Design Space 101 is divided into four quadrants. The present invention may only exist, with positive insert clearance relative to the surface produced by the cutting action, in Quadrants I and III and noting that any configuration exactly on the IAA axis (that is, RPO=0) does not provide needed clearance. Of a practical matter, configurations that fall very close to RPO=0 will theoretically provide clearance but likely not of a practically sufficient level.

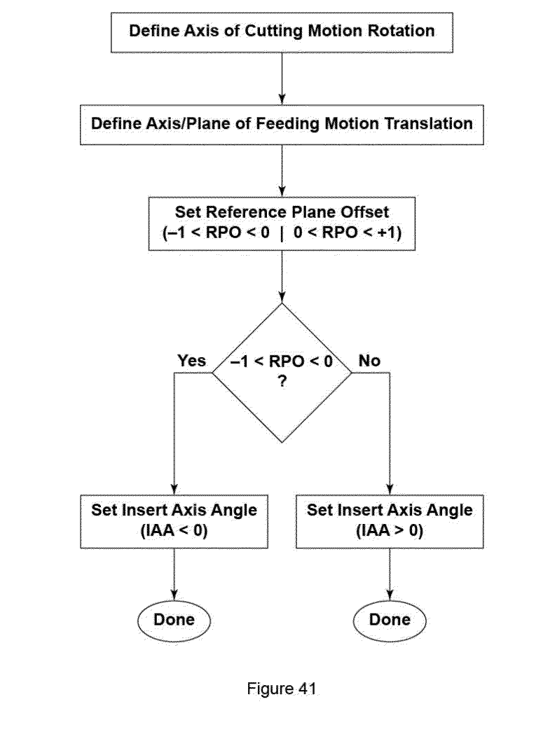

FIG. 40 shows Design Space 101 with general regions of the various embodiments of the present invention discussed and a few comparative conventional process applications for reference. Those of the present invention (tangentially-mounted round cutting inserts) are:

Chipper Drum/Peripheral End Mill/Slab Mill: 102

Cylinder-Boring Tool: 103

Face Milling Tool/Canting Mill: 104

Chipper Disc (Inward Cutting): 105

Chipper Disc (Outward Cutting): 106

Face Milling Tool/Canting Mill Wiper (Inward Cutting): 107

Face Milling Tool/Canting Mill Wiper (Outward Cutting): 108

Lathe Turning Tool: 109

Lathe Facing Tool: 110

Those of conventional mounting of inserts include, for relative comparison:

Conventional Cylinder-Boring Tool: 111

Face Milling Tool: 112

Frusto-conical Insert Face Milling Tool (using insert of U.S. Pat. No. 4,621,195): 113

The present invention includes the general method that is used to design any cutting tool using tangentially-mounted round cutting inserts. The steps and their relationships are shown in FIG. 41.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A device for removing material from an object, thereby creating one or more chips of removed material while producing a new surface on the object, the device comprising:
a. a body that is rotatable about an axis;
b. at least one round cutting insert mounted on the body so that an orientation of the insert is characterized by a reference plane offset and an insert axis, the insert having
i. a rake surface that is outwardly facing relative to an insert axis, for forming a chip;
ii. a flank surface that is oriented relative to a cutting motion so as to provide clearance between the cutting insert and a surface created by removal of a layer that is converted into one or more chips; and
iii. a circular cutting edge at the intersection of the flank and rake surfaces.

2. The device of claim 1, where the body is non-rotatable and the object is rotatable, the orientation of the cutting insert being characterized in relation to the object.

3. The device of claim 1, further including a passage to communicate coolant from a source to a rake face coolant exhaust opening.

4. The device of claim 3, in which two or more round cutting inserts are distributed circumferentially around the body, the round cutting inserts having the same or differing orientations.

5. The device of claim 4, in which the round cutting inserts are also distributed axially on the body.

6. The device of claim 4, in which the round cutting inserts are also distributed radially on the body.

7. The device of claim 4, in which the round cutting inserts are also distributed axially and radially on the body.

8. A round cutting insert having:
a. one or more rake surfaces that are outwardly facing relative to an insert axis for forming chips;
b. a flank surface corresponding to each rake surface that is oriented relative to a cutting motion to provide clearance between the cutting insert and a surface created by removal of a layer that is converted into one or more chips; and
c. a circular cutting edge at the intersection of each flank surface and its corresponding rake surface.

9. The round cutting insert of claim 8, having a hole that passes through the insert.

10. The round cutting insert of claim 8, having a circumferential groove remote from a cutting edge.

11. The round cutting insert of claim 10, in which at least one cutting edge comprises an intersection of a flank surface and a circumferential groove.

12. The round cutting insert of claim 9, having at least one mounting element recess adjacent to at least one flank surface.

13. The round cutting insert of claim 9, having at least one flank groove communicating from at least one hole to a position radially inboard of at least one cutting edge.

14. The round cutting insert of claim 9, having at least one flank groove communicating from at least one hole to and through at least one cutting edge.

15. The round cutting insert of claim 8, in which each flank surface is planar.

16. The round cutting insert of claim 8, in which the tangent to each flank surface adjacent to its cutting edge is conical.

17. The round cutting insert of claim 9, having a mounting element passing through a hole.

18. The round cutting insert of claim 17, in which the mounting element has at least one passage on its outer diameter surface.

19. The round cutting insert of claim 8, in which each rake surface is cylindrical.

20. The round cutting insert of claim 8, in which the tangent to each rake surface adjacent to its cutting edge is conical.

21. A method for designing a device for removing material from an object, thereby creating one or more chips of removed material while producing a new surface on the object, the device comprising:
a. a body that is rotatable about an axis;
b. at least one round cutting insert mounted on the body so that an orientation of the insert is characterized by a reference plane offset and an insert axis, the insert having:
i. a rake surface that is outwardly facing relative to an insert axis, for forming a chip;
ii. a flank surface that is oriented relative to a cutting motion so as to provide a means for clearance between the cutting insert and a surface created by removal of a layer that is converted into one or more chips; and
iii. a circular cutting edge at the intersection of the flank and rake surfaces;
the method comprising, not necessarily in the sequence described, the steps of:
a. defining an axis of cutting motion rotation;
b. defining a direction of relative feeding motion between the body and object; and
c. setting an orientation of each round cutting insert so that the flank surface provides clearance between the cutting insert and the surface created by removal of a layer that is converted into one or more chips.

22. The method of claim 21, in which the step of setting the orientation of each round cutting insert includes:
a. setting a rake plane offset to be either greater than zero or less than zero; and
b. setting an insert axis angle to be, respectively, greater than zero or less than zero.
